(19) United States
(12) Patent Application Publication
(10) Pub. No.: US 2026/0019543 A1
(43) Pub. Date: Jan. 15, 2026

(54) IMAGE PROJECTION APPARATUS, METHOD, AND STORAGE MEDIUM

(71) Applicant: SAMSUNG ELECTRONICS CO., LTD., Suwon-si (KR)

(72) Inventors: Hyungjun LIM, Suwon-si (KR); Hyunku Kang, Suwon-si (KR)

(73) Assignee: SAMSUNG ELECTRONICS CO., LTD., Suwon-si (KR)

(21) Appl. No.: 19/287,033

(22) Filed: Jul. 31, 2025

Related U.S. Application Data
(63) Continuation of application No. PCT/KR2025/009904, filed on Jul. 8, 2025.

(30) Foreign Application Priority Data
Jul. 9, 2024 (KR) 10-2024-0090589
Dec. 3, 2024 (KR) 10-2024-0177294

(51) Int. Cl. H04N 9/31

(52) U.S. Cl. CPC H04N 9/3185; H04N 9/3194

(57) ABSTRACT

An image projection apparatus includes: at least one sensor; an image projector; at least one memory including a non-volatile storage medium storing instructions; and at least one processor including processing circuitry, where, when executed individually or collectively by the at least one processor, the instructions cause the image projection apparatus to: model a first image display region including first pixel projection points according to a curvature characteristic of a projection plane based on sensing data of the at least one sensor; obtain second position information about second pixel projection points included in a second image display region according to a viewpoint of the projection plane, based on first position information about the first pixel projection points; and generate an output image including correct an input image based on the second position information, according to the curvature characteristic of the projection plane.

### CROSS-REFERENCE TO RELATED APPLICATION(S)

This application is a continuation of an International application No. PCT/KR2025/009904 designating the United States, filed on Jul. 8, 2025, in the Korean Intellectual Property Receiving Office, which claims priority from Korean Patent Application No. 10-2024-0090589, filed on Jul. 9, 2024, and Korean Patent Application No. 10-2024-0177294, filed on Dec. 3, 2024, in the Korean Intellectual Property Office, the disclosures of each of which are incorporated by reference herein in their entireties.

### BACKGROUND

### 1. Field

The disclosure relates to an image projection apparatus, method, and storage medium for displaying an image on a projection surface.

### 2. Description of Related Art

Projection devices may be analog-type projection devices (“analog projection devices”) or digital-type projection devices (“digital projection devices”). An analog projection device may provide visual information using a medium, such as a film. The digital projection device may provide visual information using digital signals. The digital projection device may include a beam projector (hereinafter referred to as “projector”). The projector may be classified as a display device. The projector may be implemented as a cathode ray tube (CRT) projector, a liquid crystal display (LCD) projector, or a digital light processing (DLP) projector depending on how light is generated.

The projector is used mainly to display multimedia content that is directly input to the projector. When the projector is connected to an electronic device a digital television, through a wired or wireless communication network, the projector can display the multimedia content received from the electronic device.

The projector may be an electronic device that may project photos, pictures, text, images, or video on the screen through a lens. The projector may also be called an image projection apparatus. The projector may convert data about an image or video in the form of a file into an optical signal (or optical image) and output it. The output of the optical signal may correspond to an irradiation. The optical signal output by the projector may be projected on the screen to provide an image to the viewer.

The projector can display (project) an image on a non-planar projection surface, as well as a planar surface, to expand the projection region of the projector. In this case, distortion may occur in the image to be projected onto the non-planar projection surface.

The above-described information may be provided as related art for the purpose of helping understanding of the disclosure. The foregoing cannot be claimed as, or used to determine, the related art related to the disclosure.

### SUMMARY

Aspects will be set forth in part in the description which follows and, in part, will be apparent from the description, or may be learned by practice of the presented embodiments.

According to an aspect of the disclosure, an image projection apparatus may include: at least one sensor; an image projector; at least one memory including a non-volatile storage medium storing instructions; and at least one processor including processing circuitry, where, when executed individually or collectively by the at least one processor, the instructions cause the image projection apparatus to: model a first image display region including first pixel projection points according to a curvature characteristic of a projection plane based on sensing data of the at least one sensor; obtain second position information about second pixel projection points included in a second image display region according to a viewpoint of the projection plane, based on first position information about the first pixel projection points; and generate an output image including correct an input image based on the second position information, according to the curvature characteristic of the projection plane.

When executed individually or collectively by the at least one processor, the instructions may further cause the image projection apparatus to: obtain a first depth value of the first pixel projection points included in the projection plane based on the sensing data of the at least one sensor; and obtain the first position information about the first pixel projection points based on the first depth value, and obtain third position information about third pixel projection points included in a virtual projection plane, where the first position information includes information about a position in a three-dimensional (3D) orthogonal coordinate system, and the second position information and the third position information respectively include information about a position in a planar orthogonal coordinate system.

When executed individually or collectively by the at least one processor, the instructions may further cause the image projection apparatus to: perform an interpolation using the first depth value to obtain a second depth value of the first pixel projection points; and apply the second depth value to the third position information to obtain the first position information.

When executed individually or collectively by the at least one processor, the instructions may further cause the image projection apparatus to: convert a first 3D orthogonal coordinate system of the first pixel projection points into a second 3D orthogonal coordinate system of the second pixel projection points with respect to the viewpoint; and project the second 3D orthogonal coordinate system onto a coordinate plane to obtain the second position information.

When executed individually or collectively by the at least one processor, the instructions may further cause the image projection apparatus to: correct the input image including adjust a size of a target pixel value based on the second position information to be inversely proportional to a depth value of the target pixel value in the second 3D orthogonal coordinate system.

When executed individually or collectively by the at least one processor, the instructions may further cause the image projection apparatus to: determine a specific weight based on a screen-to-image ratio; and obtain, based on the second position information, information about a pixel coordinate system of a target pixel according to the specific weight and a separation distance between the target pixel and a reference pixel that corresponds to a center point in the second image display region.

When executed individually or collectively by the at least one processor, the instructions may further cause the image projection apparatus to: determine a specific weight based on a screen-to-image ratio; obtain, based on the second position information, a first separation distance in a horizontal axis and a second separation distance in a vertical axis between a reference pixel and a target pixel with respect to a planar orthogonal coordinate system of the reference pixel, wherein the reference pixel corresponds to a center point of the second image display region; and obtain information about a pixel coordinate system of the target pixel according to the specific weight, the first separation distance, and the second separation distance.

The virtual projection plane may include a virtual plane facing the image projection apparatus at a predetermined distance between the projection plane and the image projection apparatus.

When executed individually or collectively by the at least one processor, the instructions may further cause the image projection apparatus to: set the third position information according to the predetermined distance between the image projection apparatus and the virtual projection plane.

When executed individually or collectively by the at least one processor, the instructions may further cause the image projection apparatus to: obtain the curvature characteristic of the projection plane based on the sensing data; based on determining that the projection plane is a flat surface based on the curvature characteristic, perform a planar distortion correction on the input image to generate the output image; based on determining that the projection plane is a multiple-plane surface based on the curvature characteristic, perform a multiple-plane distortion correction on the input image to generate the output image; and based on determining that the projection plane is a curved surface based on the curvature characteristic, perform a curvature distortion correction on the input image to generate the output image.

According to an aspect of the disclosure, a method for operating an image projection apparatus may include: modeling a first image display region including first pixel projection points according to a curvature characteristic of a projection plane based on sensing data of at least one sensor; obtaining second position information about second pixel projection points included in a second image display region according to a viewpoint of the projection plane, based on first position information about the first pixel projection points; and generating an output image including correcting an input image based on the second position information, according to the curvature characteristic of the projection plane.

The modeling the first image display region may include: obtaining a first depth value of the first pixel projection points included in the projection plane based on the sensing data of the at least one sensor; and obtaining the first position information about the first pixel projection points based on the first depth value, and obtaining third position information about third pixel projection points included in a virtual projection plane, where the first position information includes information about a position in a three-dimensional (3D) orthogonal coordinate system, and the second position information and the third position information respectively include information about a position in a planar orthogonal coordinate system.

The method may further include obtaining the information about the 3D orthogonal coordinate system, where the obtaining the information includes: performing interpolation using the first depth value to obtain a second depth value of the first pixel projection points; and applying the second depth value to the third position information to obtain the first position information.

The method may further include obtaining the information about the planar orthogonal coordinate system, where the obtaining the information includes: converting a first 3D orthogonal coordinate system of the first pixel projection points into a second 3D orthogonal coordinate system of the second pixel projection points with respect to the viewpoint; and projecting the second 3D orthogonal coordinate system onto a coordinate plane to obtain the second position information.

The correcting the input image may include adjusting a size of a target pixel value based on the second position information to be inversely proportional to a depth value corresponding to the target pixel value in the second 3D orthogonal coordinate system.

The generating the output image may further include: determining a specific weight based on a screen-to-image ratio; and obtaining, based on the second position information, information about a pixel coordinate system of a target pixel based on the specific weight and a separation distance between the target pixel and a reference pixel that corresponds to a center point in the second image display region.

The generating the output image further comprises: determining a specific weight based on a screen-to-image ratio; obtaining, based on the second position information, a first separation distance in a horizontal axis and a second separation distance in a vertical axis between a reference pixel and a target pixel using a planar orthogonal coordinate system of the reference pixel, wherein the reference pixel corresponds to a center point of the second image display region; and obtaining information about a pixel coordinate system of the target pixel according to the specific weight, the first separation distance, and the second separation distance.

The virtual projection plane may include a virtual plane facing the image projection apparatus at a predetermined distance between the projection plane and the image projection apparatus.

The method may further include setting the third position information according to the predetermined distance between the image projection apparatus and the virtual projection plane.

The method may further include: obtaining the curvature characteristic of the projection plane based on the sensing data; based on determining that the projection plane is a flat surface based on the curvature characteristic, generating the output image further includes performing planar distortion correction on the input image; based on determining that the projection plane is a multiple-plane surface based on the curvature characteristic, generating the output image further includes performing a multiple-plane distortion correction on the input image; and based on determining that the projection plane is a curved surface based on the curvature characteristic, generating the output image further includes performing a curvature distortion correction on the input image.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating an operation of projecting an image onto a curved projection plane in an image projection system according to an embodiment;

FIG. 2 is a view illustrating an example in which an image is projected onto a curved projection plane in an image projection system according to an embodiment;

FIG. 3 is a view illustrating obtaining projection points based on measurement points in an image projection apparatus according to an embodiment;

FIG. 4 is a block view illustrating a configuration for projecting image data in an image projection apparatus according to an embodiment;

FIG. 5 is a flowchart illustrating control for obtaining position data of an area where image data is to be projected in an image projection apparatus according to an embodiment;

FIG. 6 is a view illustrating an operation performed step by step for image correction in an image projection apparatus according to an embodiment;

FIG. 7 is a view illustrating an operation of obtaining position data of pixel projection points for projection screen modeling;

FIG. 8A and FIG. 8B are views illustrating projection screen modeling step by step according to various embodiments;

FIG. 9 is a view illustrating a viewpoint conversion operation of converting a projection region based on a viewpoint of a viewer according to an embodiment;

FIG. 10 is a view illustrating an image correction operation according to an embodiment;

FIG. 11 is a flowchart illustrating control for performing image correction in an image projection apparatus according to an embodiment;

FIG. 12A is an example view illustrating displaying an image on a single flat surface by flat surface distortion correction according to an embodiment;

FIG. 12B is an example view illustrating an image displayed on a multi-plane surface by multi-plane surface distortion correction according to an embodiment;

FIG. 12C is an example view illustrating displaying an image on a non-planar surface by non-planar surface distortion correction according to an embodiment; and

FIG. 13 is a view illustrating an electronic device in a network environment according to various embodiments.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

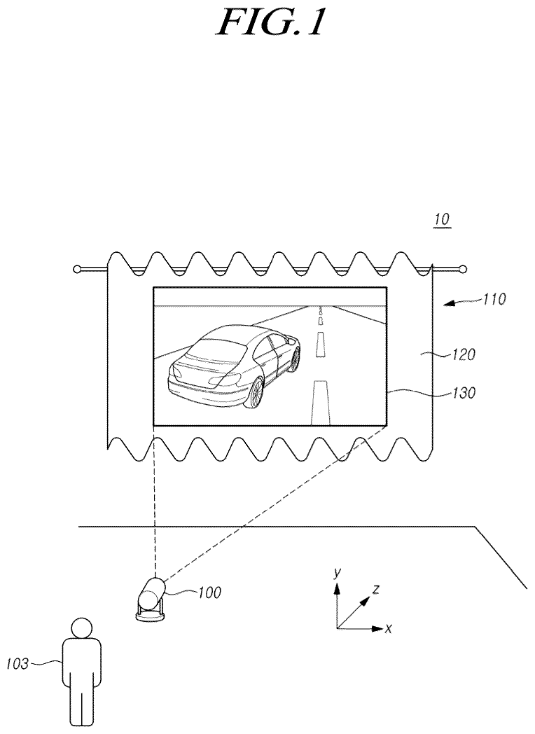

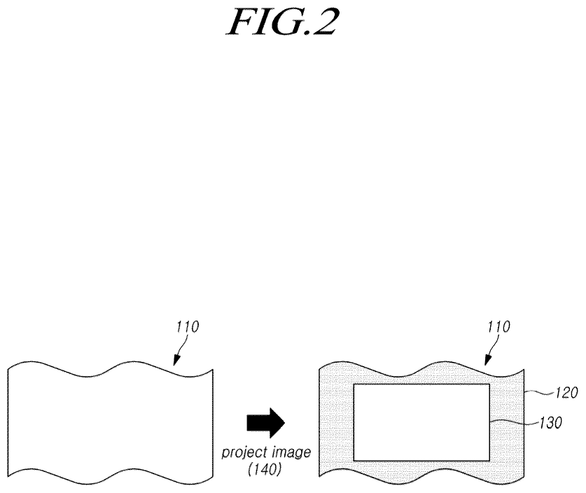

FIG. 1 is a view illustrating an operation of projecting an image on a curved projection plane 110 in an image projection system 10 according to an embodiment, and FIG. 2 is a view illustrating an example of projecting an image on the curved projection plane 110 in an image projection system 10 according to an embodiment.

Referring to FIG. 1 or FIG. 2, the image projection system 10 may include an image projection apparatus 100 (e.g., a beam projector) or a projection plane 110. The projection plane 110 may be a flat surface, a multi-plane surface having at least two planes, or a non-planar surface. According to an example, the projection plane 110 may be a non-planar, curved surface having a predetermined curvature characteristic. In this case, the projection plane 110 may be referred to as a ‘curved projection plane’. The curved projection plane may be made by a curtain, tent, or banner. In the disclosure, a projection plane not specified as a ‘planar projection plane’ may be used to refer to the curved projection plane 110. The curvature characteristic may be a characteristic related to the shape in which the projection plane 110 is bent or curved. The curvature characteristic of the projection plane 110 may include the characteristic of a wave formed by crests and roots in a predetermined direction, such as horizontal (or left and right), vertical (or up and down), or diagonal direction. In this case, the curvature characteristic may have an inclined surface due to the formation of a crest and a root. The inclined surface may have a predetermined inclination.

According to an example, the projection plane 110 may include a projection region 120. The projection region 120 may be an area which the light may reach by the beam projected (140) by the image projection apparatus 100 on the projection plane 110. The projection region 120 may have a curvature characteristic substantially identical or similar to that of the projection plane 110.

According to an example, the projection region 120 may include an image display region 130. The image display region 130 may be an area where an image is substantially displayed by the beam projected (140) by the image projection apparatus 100 in the projection region 120. The image display region 130 may have a curvature characteristic substantially identical or similar to that of the projection plane 110.

The image projection apparatus 100 may correct input image data (hereinafter referred to as an ‘input image’) into output image data (hereinafter referred to as an ‘output image’) and convert the corrected output image into an optical signal and project (140) the output image. The input image may be image data input according to a content service such as a movie or a game. According to an example, the image projection apparatus 100 may generate an output image by correcting an input image based on the curvature characteristic of the projection plane 110.

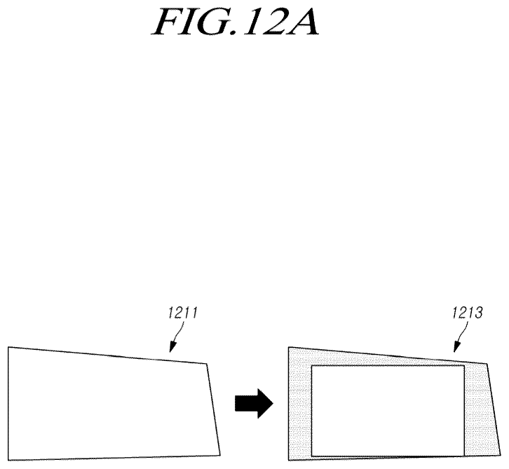

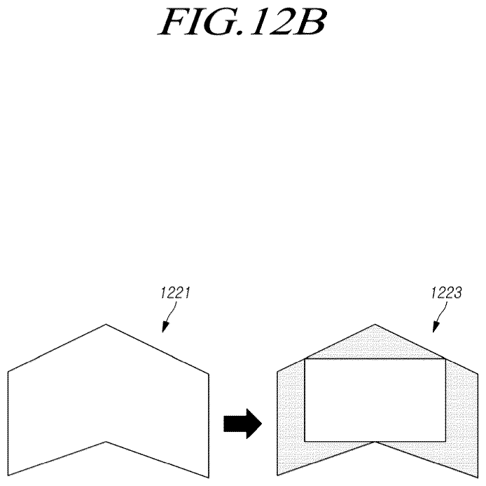

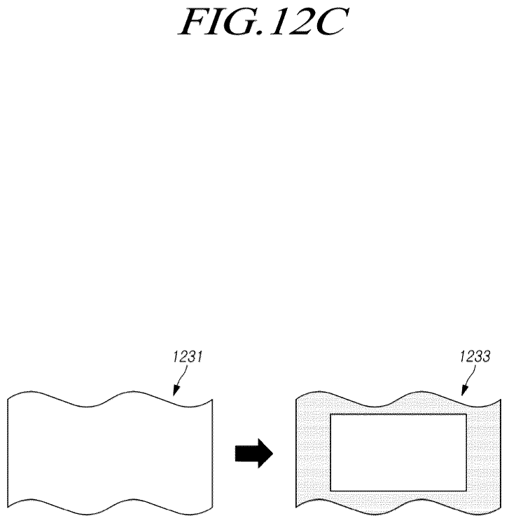

The optical signal projected (140) by the image projection apparatus 100 may reach the projection region 120 of the projection plane 110. The image projection apparatus 100 may generate an output image by performing a plane distortion correction such as keystone correction on the input image if the projection plane 110 is flat like a screen (see FIG. 12A). When the projection plane 110 is a multiple-plane surface (e.g., multi-plane surface), the image projection apparatus 100 may generate an output image by performing multi-plane distortion correction on the input image (see FIG. 12B). The image projection apparatus 100 may generate an output image by performing non-planar distortion correction on the input image when the projection plane 110 is non-planar, such as a curved surface (see FIG. 12C). In other words, the image projection apparatus 100 may perform a correction on the input image so that the image displayed on the image display region 130 may look like a planar image without distortion considering the curvature characteristic of the projection plane 110. According to an embodiment of the disclosure, the correction on the input image may be an automatic correction (auto keystone) on the input image. Detailed operations regarding automatic correction for displaying an undistorted image like a planar image on the projection plane 110 (e.g., a curved projection plane) having a curvature characteristic corresponding to a non-planar surface by the image projection apparatus 100 are described below with reference to other drawings.

According to an example, the image projection apparatus 100 may correct the output image by reflecting the viewpoint of the viewer 103. In this case, the output image before correction may be an image in which the input image is corrected to project (140) an optical signal onto the image display region 130 modeled to reflect the curvature characteristic of the projection plane 110. For example, the image projection apparatus 100 may change the coordinate value of the pixel projection point, where the pixels of the output image corrected by reflecting the curvature characteristic are to be projected onto the first image display region, to the coordinate value of the pixel projection point to be projected onto the second image display region. The first image display region may be an image display region determined to correspond to the viewpoint of the image projection apparatus 100. The second image display region may be an image display region determined to correspond to the viewpoint of the viewer 103. For example, when the image projection apparatus 100 projects a planar image into the first image display region considering only the curvature characteristic of the projection plane 110, the viewer 103 at a position away from the image projection apparatus 100 may not recognize the image displayed in the first image display region as a planar image. To solve this problem, the image projection apparatus 100 may change the first image display region into the second image display region considering the viewpoint of the viewer 103. In this case, the image projection apparatus 100 may provide a planar image optimized for the viewpoint of the viewer 103 on the projection plane 110 with a specific curvature characteristic by correcting the input image considering both the curvature characteristic of the projection plane 110 and the viewpoint of the viewer 103.

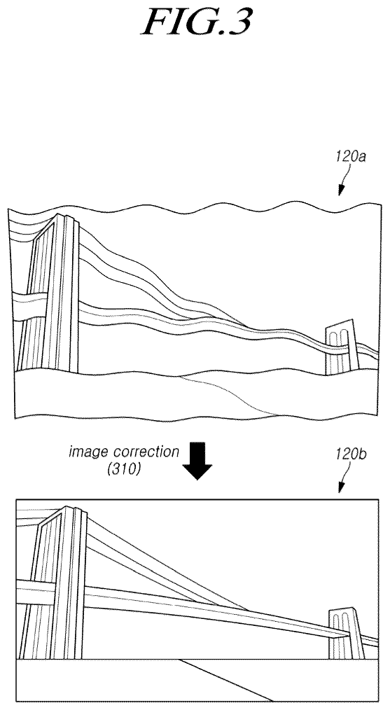

FIG. 3 is a view illustrating obtaining projection points based on measurement points in an image projection apparatus (e.g., the image projection apparatus 100 of FIG. 1) according to an embodiment.

For example, the measurement points may be regularly or irregularly distributed points where the beam output by at least one distance sensor (e.g., a time of flight (ToF) sensor) to obtain position data corresponding to the projection plane (e.g., the projection plane 110 of FIG. 1 and/or the projection region (e.g., the projection region 120 of FIG. 1)) reaches the projection plane 110 and/or the projection region 120. Hereinafter, the measurement points are referred to as ‘sensing measurement points’. For example, the projection points may be points where the beams transmitted by the image projection apparatus 100 to display an image in the image display region (e.g., the image display region 130 of FIG. 1) reach the projection plane 110 and/or the projection region 120 to display pixels that will constitute a display image. Hereinafter, the projection points are referred to as ‘pixel projection points’.

Referring to FIG. 3, the image projection apparatus 100 may obtain position data (hereinafter referred to as ‘first position data’) corresponding to a plurality of sensing measurement points included in the projection plane 110 using a distance sensor such as a ToF sensor. For example, the first position data may include a space orthogonal coordinate (or three-dimensional (3D) orthogonal coordinate system) (hereinafter referred to as a ‘space orthogonal coordinate system’) corresponding to the position of each of sensing measurement points in the coordinate space. For example, the space orthogonal coordinate system corresponding to the position of each of the sensing measurement points may be referred to as a ‘first coordinate value P1(x, y, z)’. For example, the projection plane 110 may include about 250 sensing measurement points. In this case, the first position data may include about 250 first coordinate values. The first screen 120a exemplarily shows an image in which the image projection apparatus 100 displays an input image in an image display region (e.g., the image display region 130 of FIG. 1) without correction considering the curvature characteristic of the non-planar surface projection plane 110. The image projection apparatus 100 may generate output data for displaying the first screen 120a by performing only flat surface distortion correction on the input image. On the first screen 120a, it may be identified that distortion due to the curvature of the projection plane 110 is present.

According to an example, the image projection apparatus 100 may perform image correction on the input image to reflect the curvature characteristic of the projection plane 110 (310). For example, the sensing measurement points may be irregularly distributed due to the curvature characteristic of the projection plane 110. The separation distance between the sensing measurement points distributed near the crest and/or root on the projection plane 110 may be different from the separation distance between the sensing measurement points distributed on the inclined surface. For example, the sensing measurement points may be relatively densely distributed near the crest and/or the valley of the projection plane 110. In consideration of the characteristic, the first position data obtained by the image projection apparatus 100 for the sensing measurement points may be unstructured scattered data. Here, “structured” means that a specific structure or order is set between relative positions. The image projection apparatus 100 may perform data interpolation for obtaining position data corresponding to the plurality of pixel projection points based on the first position data corresponding to a small number of sensing measurement points. According to the example, the position data corresponding to the pixel projection points may be data defining the position where pixels of the output image are projected onto the coordinate plane corresponding to the image display region 130 by performing data interpolation using the first position data. As described above, an operation in which the image projection apparatus 100 obtains the position data corresponding to the pixel projection points using the first position data may be referred to as a ‘projection screen modeling operation’ and/or a ‘modeling operation’.

According to an example, the image projection apparatus 100 may perform a pre-processing process on the first position data before performing the projection screen modeling operation. For example, the image projection apparatus 100 may determine the second position data on a coordinate plane reflecting the curvature characteristic of the projection plane 110 based on the first position data. The image projection apparatus 100 may perform data interpolation using the second position data to obtain third position data corresponding to the pixel projection points where an optical signal is to be projected onto the projection region 120 of the projection plane 110. The third position data may include a space orthogonal coordinate system corresponding to the position of each of the pixel projection points in the coordinate space. The second screen 120b exemplarily shows an image displayed on the image display region 130 by correcting the input image considering the curvature characteristic of the non-planar projection plane 110. It may be identified that the second screen 120b does not have distortion due to the curvature of the projection plane 110 or is a planar image with reduced distortion compared to the first screen 120a.

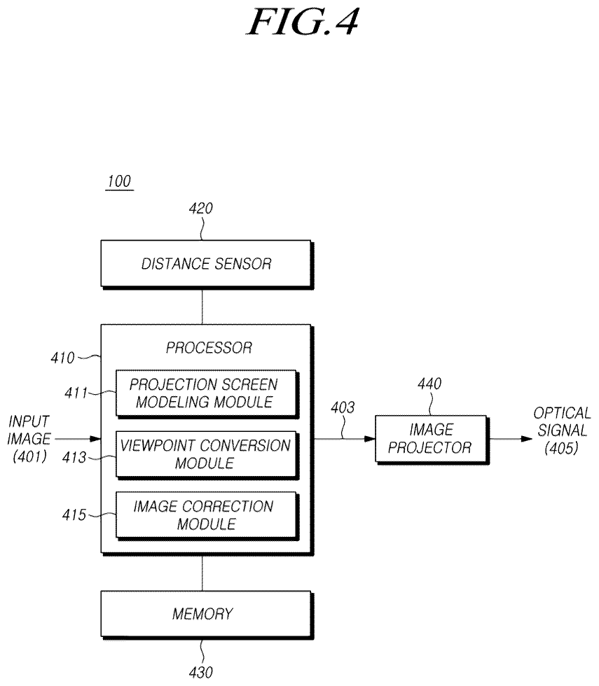

FIG. 4 is a block view illustrating a configuration for projecting image data in an image projection apparatus (e.g., the image projection apparatus 100 of FIG. 1) according to an embodiment.

Referring to FIG. 4, the image projection apparatus 100 may include at least one processor 410 (hereinafter, referred to as the processor 410), at least one sensor, at least one memory 430 (hereinafter, referred to as the memory 430), or an image projector 440. At least one sensor may include a distance sensor 420. The distance sensor 420 may be a ToF sensor or a ToF camera.

The distance sensor 420 may obtain position data (hereinafter, referred to as ‘first position data’ or ‘first coordinate value’) corresponding to a plurality of sensing measurement points included in the projection plane (e.g., the projection plane 110 of FIG. 1). The sensing measurement points may be distributed in the projection plane 110 and/or the projection region (e.g., the projection region 120 of FIG. 1). According to an example, when the projection plane 110 is a curved surface, the sensing measurement points may not be uniformly distributed on the projection plane 110 and/or the projection region 120 but may be irregularly dispersed and disposed. For example, assuming a distance sensor 420 that transmits beams so that the sensing measurement points are evenly distributed on the planar projection plane, the beams transmitted by the distance sensor 420 may provide a distribution of densely spaced sensing measurement points according to the inclination of the curved projection plane 110. In other words, the sensing measurement points present in a highly inclined area (hereinafter, a ‘first inclined surface’) in the curved projection plane 110 may be distributed and disposed at relatively far spaced apart compared to the sensing measurement points present in a relatively less inclined area (hereinafter, a ‘second inclined surface’). Therefore, the density of the sensing measurement points on the first inclined surface may be relatively lower than the density of the sensing measurement points on the second inclined surface. For example, the first inclined surface may be distinguished based on the difference in the degree of inclination relative to the second inclined surface due to the curvature of the projection plane 110, which may be an exemplary assumption.

The at least one sensor may provide sensing data related to the position of the image projection apparatus 100 and/or the position of the viewer (e.g., the viewer 103 of FIG. 1). The sensing data obtained by the at least one sensor may include information to be used to obtain the position of the viewer 103.

The processor 410 may predict the viewpoint where the viewer 103 views the projection plane 110 considering the position of the viewer 103 obtained based on the sensing data. The processor 410 may identify the position of the image projection apparatus 100 based on the sensing data.

The memory 430 may store various data used by at least one component (e.g., the processor 410 or the distance sensor 420) of the image projection apparatus 100. The data may include input data or output data for software (e.g., a program) and related commands. The memory 430 may include volatile memory or non-volatile memory. The program may be stored as software in the memory 430. According to an example, the memory 430 may include an operating system, middleware, or an application.

The image projector 440 may convert the output image 403 generated by the processor 410 into an optical signal 405 to be projected into the projection region 120 of the projection plane 110 for screen output. The image projector 440 may convert the output image 403, which is an electrical signal provided from the processor 410, into an optical signal 405 and output it toward the projection region 120. The output image 403, which is an electrical signal provided by the processor 410, may correspond to image data such as a photo and/or a video. The optical signal 405 projected by the image projector 440 may display a screen on an image display region (e.g., the image display region 130 of FIG. 1) included in the projection region 120.

The processor 410 may execute software to control at least one other component (e.g., a hardware or software component) such as the distance sensor 420 or the image projector 440, which is electrically connected thereto, or may process or compute various data. As at least part of the data processing or computation, the processor 410 may store instructions or data received from other components (e.g., the distance sensor 420, sensor unit 1230, user I/F, or transceiver) in the memory 430 (e.g., volatile memory), or process the instructions or data stored in the memory 430, and store the processed resulting data in the storage unit 430.

The processor 410 may be implemented as one or more integrated circuit (IC) chips and may perform various data processing. For example, the processor 410 (or an application processor (AP)) may be implemented as a system on chip (SoC) (e.g., one chip or chipset). The processor 410 may include sub components including a central processing unit (CPU), a graphics processing unit (GPU), a neural processing unit (NPU), an image signal processor (ISP), a display controller, a memory controller, a storage controller, a communication processor (CP), and/or a sensor interface. The sub components are merely exemplary. For example, processor 410 may further include other sub components. For example, some sub components may be omitted from the processor 410. For example, some sub components may be included as separate components of the image projection apparatus 100 outside the processor 410. For example, some sub components may be included in other components (e.g., a display and an image sensor).

The processor 410 (e.g., a CPU or a central processing circuit) may be configured to control sub components based on execution of instructions stored in the memory 430 (e.g., a volatile memory and/or a non-volatile memory). According to an example, the GPU (or the graphics processing circuit) included in the processor 410 may be configured to execute parallel computations (e.g., rendering). According to an example, the NPU (or neural processing circuit) included in the processor 410 may be configured to execute operations (e.g., convolution computations) for an artificial intelligence model. According to an example, the ISP (or the image signal processing circuit) included in the processor 410 may be configured to process a raw image obtained through the image sensor into a format suitable for a component in the image projection apparatus 100 or a sub component in the processor 410. According to an example, the display controller (or display control circuit) included in the processor 410 may be configured to process the image 401 obtained from the CPU, GPU, ISP, or memory 430 (e.g., volatile memory) in a suitable format to be projected onto the projection plane (e.g., the projection plane 110 of FIG. 1 or FIG. 2). According to an example, the memory controller (or memory control circuit) included in the processor 410 may be configured to control reading data from volatile memory and writing data to volatile memory. According to an example, the storage controller (or storage control circuit) included in the processor 410 may be configured to control reading data from nonvolatile memory and writing data to nonvolatile memory. According to an example, the CP (communication processing circuit) included in the processor 410 may be configured to process data obtained from a sub component in the processor 410 into a format suitable for transmitting the data to another electronic device through the transceiver, or to process data obtained from another electronic device (e.g., a remote controller) through the transceiver into a format suitable for processing by the sub component. According to an example, the sensor interface (or sensing data processing circuit or sensor hub) included in the processor 410 may be configured to process data about the state of the image projection apparatus 100 and/or the state around the image projection apparatus 100, obtained through an internal sensor (e.g., a distance sensor (time-of-flight (ToF) sensor)) 420 or an external sensor (e.g., one or more position measurement sensors (anchors)), into a format suitable for a sub component in the processor 410.

According to an example, the processor 410 may process image data to be output as an optical signal considering the curvature characteristic of the projection plane 110 (or the projection region 120) by at least one sensor including the distance sensor 420. The curvature characteristic of the projection plane 110 may be a characteristic related to the shape in which the projection plane 110 is bent or curved. The curvature characteristic of the projection plane 110 may be the same as described above with reference to FIG. 3. The processor 410 may perform an operation of automatically correcting the input image 401 so that the image displayed in the image display region 130 of the non-planar projection plane 110 may look like a planar image without distortion if the projection plane 110 is a non-planar surface (e.g., the curved surface illustrated in FIG. 1).

According to an example, the processor 410 may include a projection screen modeling module 411, a viewpoint conversion module 413, and/or an image correction module 415.

The projection screen modeling module 411 may perform a modeling operation on the projection screen to reflect the curvature characteristic of the projection plane 110 based on the detected first position data. According to an example, the projection screen modeling module 411 may perform a modeling operation on the projection screen to obtain position data (hereinafter referred to as ‘the second position data’) of pixel projection points (e.g., actual pixel projection points 707) included in the projection region 120 or image display region 130 on which the output image is to be projected. The second position data may include information (e.g., a second coordinate value P2(x, y, z)) about the space orthogonal coordinate system. The actual pixel projection points may be distributed on the projection plane 110. According to an example, when the projection plane 110 is non-planar (or curved), the pixel projection points may be irregularly distributed rather than uniformly distributed on the projection plane 110. For example, assuming that an optical signal to display an image is transmitted so that the pixel projection points are evenly distributed on the planar projection plane, the distributed spacing of the pixel projection points may differ according to the inclination of the non-planar surface projection plane 110. In other words, pixel projection points present on the first inclined surface that is highly inclined the non-planar projection plane 110 may be spaced relatively narrowly compared to pixel projection points present on the second inclined surface with a relatively gentle inclination. For example, the first inclined surface may be an inclined surface between the crest and the valley constituting the non-planar projection plane 110. For example, the second inclined surface may correspond to the crest that is substantially a flat surface on the non-planar projection plane 110. Accordingly, the second position data obtained by the image projection apparatus 100 may include a second coordinate value that is a space orthogonal coordinate system.

According to an example, the difference in density of pixel projection points between the first inclined surface and the second inclined surface may be attributed to the difference in arrival distance (z value or depth value) from the image projection apparatus 100 (or viewer (e.g., the viewer 103 of FIG. 1)) to the pixel projection points distributed on the projection plane 110 due to the curvature of the projection plane 110. The image projection device 100 may obtain depth values of the second coordinate value by interpolating the depth value (z values) of the first coordinate values corresponding to pixel projection points.

According to an example, the projection screen modeling module 411 may obtain information about the space orthogonal coordinate system of pixel projection points on the projection plane 110 based on the first depth value included in the first position data and information about the planar orthogonal coordinate system of pixel projection points included in the virtual projection plane. The virtual projection plane may be a virtual plane facing the image projection apparatus 100 at a predetermined distance from the image projection apparatus 100 toward the projection plane 110. The projection screen modeling module 411 may set or preset information about the planar orthogonal coordinate system of pixel projection points included in the virtual projection plane. For example, the projection screen modeling module 411 may set or preset information about the second planar orthogonal coordinate system considering the distance between the image projection apparatus 100 and the virtual projection plane.

In an embodiment, the projection screen modeling module 411 may obtain a second depth value of pixel projection points on the projection plane 110 by performing interpolation using the obtained first depth value. The projection screen modeling module 411 may obtain information about the space orthogonal coordinate system of the actual pixel projection points by applying the obtained second depth value to information about the second planar orthogonal coordinate system of the virtual pixel projection points. The information about the space orthogonal coordinate system of the actual pixel projection points may include second coordinate values of the pixel projection points in the coordinate space corresponding to the projection plane 110.

The projection screen modeling module 411 may obtain first position data corresponding to sensing measurement points included in the projection plane 110 based on the sensing value measured by the distance sensor 420. The first position data may include the first coordinate value P1(x, y, z) corresponding to each of the sensing measurement points. The first coordinate value P1(x, y, z) may be a space orthogonal coordinate system obtained for the coordinate space. For example, the first coordinate value P1(x, y, z) may be defined as position data (x value, y value) corresponding to the planar orthogonal coordinate system (or two-dimensional orthogonal coordinate system) corresponding to the coordinate plane and/or position data (z value) corresponding to the depth or distance.

The viewpoint conversion module 413 may perform a viewpoint conversion operation for converting the second position data into third position data with respect to the viewpoint of the viewer 103 to view the projection plane 110. The viewpoint conversion module 413 may perform a viewpoint conversion operation to obtain third position data to allow the screen to be displayed on the non-planar image display region (e.g., the image display region 130 of FIG. 1) to be seen as a flat screen at the viewpoint where the actual viewing is performed. The third position data may be a planar orthogonal coordinate system in plane coordinates. In other words, the viewpoint conversion module 413 may convert the second position data obtained with respect to a first viewpoint, which is the viewpoint of the image projection apparatus 100, into third position data which is based on a second viewpoint, which is the viewing position. The second position data may be a space orthogonal coordinate system in spatial coordinates. The third position data may be a planar orthogonal coordinate system in plane coordinates.

According to an embodiment, the viewpoint conversion module 413 may obtain information about the planar orthogonal coordinate system to be included in the second image display region considering the viewpoint of viewing the projection plane 110 based on information about the space orthogonal coordinate system of the first pixel projection points included in the modeled first image display region. For example, the viewpoint conversion module 413 may convert the space orthogonal coordinate system of the first pixel projection points obtained with respect to the first viewpoint of viewing the projection plane 110 from its own position, into a space orthogonal coordinate system which is based on the second viewpoint of viewing the projection plane 110 from the position of the viewer 103. The viewpoint conversion module 413 may project the space orthogonal coordinate system based on the second viewpoint onto the coordinate plane 2D to obtain information (e.g., third position data) about the planar orthogonal coordinate system at the second viewpoint.

The image correction module 415 may generate an output image 403 by correcting the input image 401 based on the third position data obtained by the viewpoint conversion module 413 so that the image to be projected onto the non-planar surface projection region 120 may be viewed as a planar image to the viewer (e.g., the viewer 103 of FIG. 2). The image correction module 415 provides the output image 403 to the image projector 440 so that the optical signal 405 may be transmitted to the projection plane 110.

According to an example, the image projection apparatus 100 may include an additional component such as a user interface (I/F). For example, the user I/F may be configured to receive information from the user. The user I/F may receive a command or data to be used by other component (e.g., the processor 410) of the image projection apparatus 100, from the outside (e.g., a user) of the image projection apparatus 100. The user I/F may include a microphone, a mouse, a keyboard, a key (e.g., a button), a remote controller, or a digital pen (e.g., a stylus pen). According to an example, the user I/F may be configured to transfer information to the user. The user I/F may output sound signals to the outside of the image projection apparatus 100 through a component such as a speaker. For example, the speaker may be used for general purposes, such as playing multimedia or playing record.

According to an example, the image projection apparatus 100 may include an additional component such as a transceiver. The transceiver 840 may be configured to exchange information with at least one electronic device. The transceiver may transmit/receive data or signals with a remote controller or external sensors under the control of the processor 410.

According to an example, the transceiver may include, but is not limited to, a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi direct (WFD) communication unit, an ultrawideband (UWB) communication unit, an Ant+communication unit, or a microwave (uWave) communication unit, corresponding to the performance and structure of the image projection apparatus 100.

According to an example, the transceiver may support establishing a direct (e.g., wired) communication channel or a wireless communication channel with a remote controller and performing communication through the established communication channel. The transceiver may include one or more CPs supporting direct (e.g., wired) communication or wireless communication. The one or more CPs may be operated independently of the processor 410. The transceiver may include a wireless communication module (e.g., a cellular communication module, a short-range wireless communication module, or a global navigation satellite system (GNSS) communication module) or a wired communication module (e.g., a local area network (LAN) communication module or a power line communication module). A corresponding one of these communication modules may communicate with at least one remote controller, which is an external electronic device, via a network (e.g., a short-range communication network, such as Bluetooth™, wireless-fidelity (Wi-Fi) direct, or infrared data association (IrDA)) or a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

In one example, the image projection apparatus 100 may include an external sensor as an additional component. The sensing data obtained through the external sensor may include information to be used to obtain the position of the image projection apparatus 100. The sensing data obtained through the external sensor may include information to be used to obtain the position of the viewer (e.g., the viewer 103 of FIG. 1). The image projection apparatus 100 may predict the viewpoint at which the viewer 103 views the projection plane 110 considering the position of the viewer 103 obtained based on the sensing data. The processor 410 may identify the position of the image projection apparatus 100 using the sensing data.

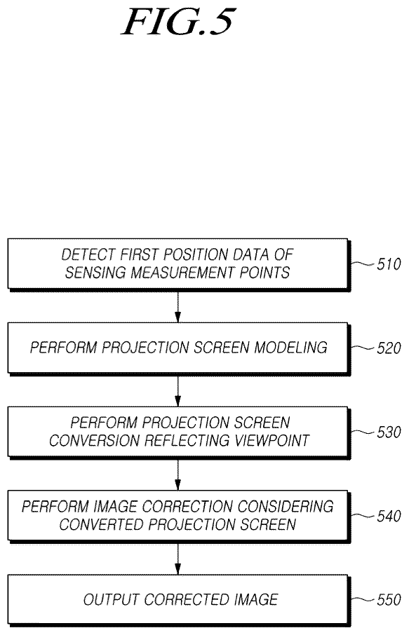

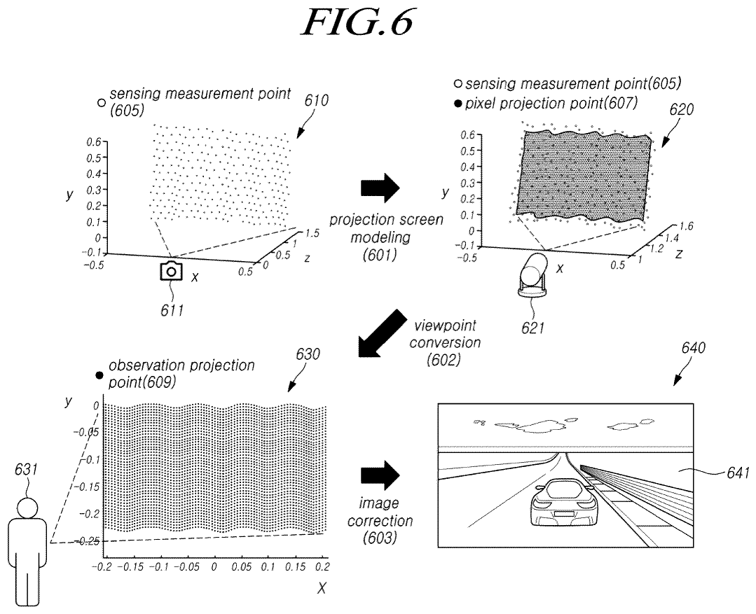

FIG. 5 is a control flowchart for obtaining position data of an area (e.g., the projection region 120 of FIG. 1 or 2) to project image data in an image projection apparatus (e.g., the image projection apparatus 100 of FIG. 1) according to an embodiment. FIG. 6 is a view illustrating operations performed step by step for image correction in an image projection apparatus 100 (e.g., the image projection apparatus 100 of FIG. 1) according to an embodiment.

In the following embodiment, each operation may be sequentially performed, but is not necessarily required to be performed sequentially. For example, the order of the operations may be changed, and at least two operations may be performed in parallel.

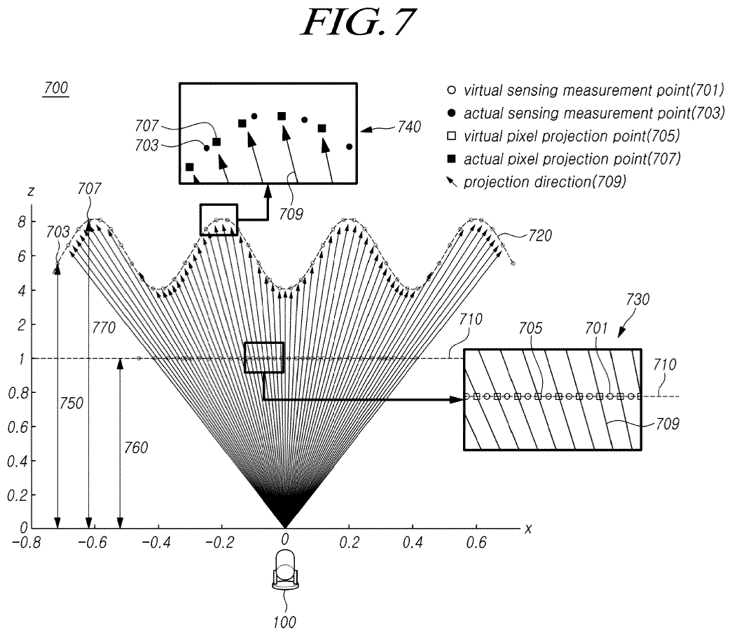

Referring to FIG. 5 or FIG. 6, in operation 510, the image projection apparatus 100 may detect position data (hereinafter referred to as ‘first position data’ or ‘first coordinate value’) corresponding to a plurality of sensing measurement points 605 (e.g., the actual sensing measurement points 703 of FIG. 7) included in the projection plane (e.g., the projection plane 110 or projection region 120 of FIG. 1) (hereinafter referred to as ‘projection plane 110’). The actual sensing measurement points 605 may be distributed on the projection plane 110. According to an example, in a state in which the projection plane 110 is planar, the sensing measurement points 605 may have a substantially uniform distribution, but when the projection plane 110 is non-planar (or curved), the sensing measurement points 605 may be irregularly distributed rather than uniformly distributed on the projection plane 110. For example, assuming at least one sensor (the distance sensor 611 of FIG. 6) that transmits beams so that the sensing measurement points 605 are evenly distributed on the planar projection plane, the beams transmitted by the sensor 611 may have different distributed spacing of the sensing measurement points 605 according to the inclination of the curved projection plane 110. For example, the sensing measurement points 605 may be distributed relatively more on the second inclined surface with a gentle inclination than on the first inclined surface with a steep inclination. In other words, sensing measurement points present on the second inclined surface with a gentle inclination on the curved projection plane 110 may be disposed at relatively narrow intervals compared to sensing measurement points present on the first inclined surface with a relatively steep inclination. Therefore, the density of the sensing measurement points on the first inclined surface may be relatively lower than the density of the sensing measurement points on the second inclined surface. For example, the first inclined surface may be distinguished based on the difference in the degree of inclination relative to the second inclined surface due to the curvature of the projection plane 110, which may be an exemplary assumption. For example, the first inclined surface may be an inclined surface between the crest and the valley constituting the non-planar projection plane 110. For example, the second inclined surface may correspond to the crest that is substantially a flat surface on the non-planar projection plane 110. Accordingly, the first position data obtained by the image projection apparatus 100 may include a first coordinate value that is a space orthogonal coordinate system.

According to an example, the difference in density of sensing measurement points 605 between the first inclined surface and the second inclined surface may be attributed to the difference in arrival distance (z value or depth value) from the image projection apparatus 100 (or viewer (e.g., the viewer 103 of FIG. 1)) to the sensing measurement points 605 distributed on the projection plane 110 due to the curvature of the projection plane 110. The curvature of the projection surface 110 may cause the distance at which the signal (e.g., an infrared (IR) beam) transmitted using at least one sensor 611 reaches the corresponding measurement point to be varied in order for the image projection apparatus 100 to obtain the first coordinate value corresponding to the sensing measurement points 605. The number of sensing measurement points 605 on the projection plane 110 may be determined by the resolution of at least one sensor 611. For example, the number of sensing measurement points 605 determined by the resolution of at least one sensor 611 may be ‘240×180’. For example, the number of sensing measurement points 605 determined by the resolution of at least one sensor 611 may be ‘640×480’. The number of pixels (e.g., the number of pixel projection points 607) of the image projected onto the projection region 120 of the projection plane 110 by the image projection apparatus 100 may be relatively larger than the number of sensing measurement points 605. According to an example, the image projection apparatus 100 may obtain position data (hereinafter referred to as ‘the second position data’) of pixel projection points 607 (e.g., the actual pixel projection points 707 of FIG. 7) based on the first position data of the sensing measurement points 605 using a specific interpolation technique. This is described below in greater detail.

According to an example, the image projection apparatus 100 may obtain the first coordinate value P1(x, y, z) as first position data corresponding to the plurality of sensing measurement points 605 included in the curved projection plane 110. The first coordinate value P1(x, y, z) may be a space orthogonal coordinate system obtained for the coordinate space 610. For example, the first coordinate value P1(x, y, z) may be defined as position data (x value, y value) corresponding to a planar orthogonal coordinate system (or two-dimensional (2D) orthogonal coordinate system) corresponding to the coordinate plane and position data (z value) corresponding to the depth or distance. Table 1 below shows an example of the first coordinate values obtained by the image projection apparatus 100.

TABLE 1

| | X | Y | Z |
|---|---|---|---|
| 1 | −0.98207 | −0.80404 | 1.903817 |
| 2 | −0.98871 | 0.178118 | 1.981639 |
| 3 | −0.98231 | 0.025504 | 1.969155 |
| 4 | −0.9793 | −0.13446 | 1.962827 |
| 5 | −0.97369 | −0.28382 | 1.950461 |
| 6 | −0.97128 | −0.44164 | 1.942336 |
| . . . | . . . | . . . | . . . |

As described above, the image projection apparatus 100 may detect first position data (or first coordinate values P1(x, y, z)) in the coordinate space 610 corresponding to the sensing measurement points 605 distributed on the projection plane 110 by at least one sensor 611. The first position data may include the depth value (e.g., the z value) from the image projection apparatus 100 to the sensing measurement point 605.

In operation 520, the image projection apparatus 100 may perform a modeling operation 601 on the projection screen to reflect the curvature characteristic of the projection plane 110 based on the detected first position data. According to an example, the image projection apparatus 100 may perform a modeling operation 601 on the projection screen to obtain position data (hereinafter referred to as ‘the second position data’) of pixel projection points 607 (e.g., actual pixel projection points 707) included in the projection region 120 or image display region 130 on which the output image is to be projected. The second position data may include information (e.g., a second coordinate value P2(x, y, z)) about the space orthogonal coordinate system.

The actual pixel projection points 607 may be distributed on the projection plane 110. According to an example, when the projection plane 110 is non-planar (or curved), the pixel projection points 607 may be irregularly distributed rather than uniformly distributed on the projection plane 110. For example, assuming an optical signal to display an image is transmitted so that the pixel projection points 607 are evenly distributed on the planar projection plane, the distributed spacing of the pixel projection points 607 may differ according to the inclination of the curved surface projection plane 110. For example, the pixel projection points 607 may be distributed relatively more densely on the second inclined surface with a steep inclination than on the second inclined surface with a gentle inclination. In other words, pixel projection points present on the second inclined surface with a gentle inclination on the curved projection plane 110 may be disposed at relatively narrow intervals compared to pixel projection points present on the first inclined surface with a relatively steep inclination. Therefore, the density of the pixel projection points on the first inclined surface may be relatively lower than the density of the pixel projection points on the second inclined surface. For example, the first inclined surface may be distinguished based on the difference in the degree of inclination relative to the second inclined surface due to the curvature of the projection plane 110, which may be an exemplary assumption. For example, the first inclined surface may be an inclined surface between the crest and the valley constituting the non-planar projection plane 110. For example, the second inclined surface may correspond to the crest that is substantially a flat surface on the non-planar projection plane 110. Accordingly, the second position data obtained by the image projection apparatus 100 may include a second coordinate value that is a space orthogonal coordinate system.

According to an example, the difference in density of pixel projection points 607 between the first inclined surface and the second inclined surface may be attributed to the difference in arrival distance (z value or depth value) from the image projection apparatus 100 (or viewer (e.g., the viewer 103 of FIG. 1)) to the pixel projection points 607 distributed on the projection plane 110 due to the curvature of the projection plane 110. The image projection device 100 may obtain depth values of the second coordinate value by interpolating the depth value (z values) of the first coordinate values corresponding to pixel projection points.

According to an example, the image projection apparatus 100 may obtain information about the space orthogonal coordinate system of pixel projection points (e.g., the actual pixel projection points 707 of FIG. 7) on the projection plane 720 based on information about the planar orthogonal coordinate system of pixel projection points (e.g., the virtual pixel projection points 705 of FIG. 7) included in the virtual projection plane (e.g., the virtual projection plane 710 of FIG. 7) and the first depth value (e.g., the first depth value 750 of FIG. 7) included in the first position data. The virtual projection plane 710 may be a virtual plane facing the image projection apparatus 100 at a predetermined distance 760 toward the projection plane 720 from the image projection apparatus 100. The image projection apparatus 100 may preset or set information about the planar orthogonal coordinate system of the pixel projection points (e.g., the virtual pixel projection points 705 of FIG. 7) included in the virtual projection plane 710. For example, the image projection apparatus 100 may preset or set information about the second planar orthogonal coordinate system considering the distance 760 between the image projection apparatus 100 and the virtual projection plane 710.

For example, the image projection apparatus 100 may obtain the second depth value (e.g., the second depth value 770 of FIG. 7) of the actual pixel projection points 707 on the projection plane 720 by performing interpolation using the obtained first depth value 750. The image projection apparatus 100 may obtain information about the space orthogonal coordinate system of the actual pixel projection points 707 by applying the obtained second depth value 770 to information about the second planar orthogonal coordinate system of the virtual pixel projection points 705. The information about the space orthogonal coordinate system of the actual pixel projection points 707 may include second coordinate values of the pixel projection points 607 in the coordinate space 620 corresponding to the projection plane 110.

In operation 530, the image projection apparatus 100 may perform a viewpoint conversion operation 602 for converting the second position data into third position data with respect to the viewpoint of the viewer 631 to view the projection plane 720. The image projection apparatus 100 may perform a viewpoint conversion operation 602 to obtain third position data to allow the screen to be displayed on the non-planar image display region (e.g., the image display region 130 of FIG. 1) to be seen as a flat screen at the viewpoint where the actual viewing is performed. The third position data may be a planar orthogonal coordinate system in plane coordinates. In other words, the image projection apparatus 100 may convert the second position data obtained with respect to a first viewpoint, which is the viewpoint of the image projection apparatus 100, into third position data which is based on a second viewpoint, which is the viewing position. The second position data may be a space orthogonal coordinate system in spatial coordinates. The third position data may be a planar orthogonal coordinate system in plane coordinates.

According to an embodiment, the image projection apparatus 100 may obtain information about the planar orthogonal coordinate system of the observation projection points 609 to be included in the second image display region 630 considering the viewpoint of viewing the projection plane 110 based on information about the space orthogonal coordinate system of the first pixel projection points 607 included in the modeled first image display region 620.

According to an example, the image projection apparatus 100 may convert the space orthogonal coordinate system of the first pixel projection points 607 obtained with respect to the first viewpoint of viewing the projection plane 720 from its own position, into a space orthogonal coordinate system of the observation projection points 609 which are based on the second viewpoint of viewing the projection plane 720 from the viewer 631's position. The image projection apparatus 100 may obtain information about the first planar orthogonal coordinate system of the observation projection points 609 by projecting the space orthogonal coordinate system of the observation projection points 609 onto the coordinate plane 2D.

In operation 540, the image projection apparatus 100 may correct (603) the input image 401 based on the obtained information about the first planar orthogonal coordinate system considering the occurrence of distortion due to the curvature characteristic of the projection plane 720. For example, the image projection apparatus 100 may correct the input image 401 so that the size of the target pixel value to be projected is inversely proportional to the depth value corresponding to the target pixel value in the second space orthogonal coordinate system based on the information about the first planar orthogonal coordinate system. The image projection apparatus 100 may obtain information about the pixel coordinate system of the target pixel by reflecting a specific weight to the separation distance between the target pixel and the reference pixel substantially corresponding to the center point in the second image display region based on the information about the first planar orthogonal coordinate system. Based on information about the first planar orthogonal coordinate system, the image projection apparatus 100 may obtain the first separation distance on the horizontal axis (x axis) between the reference pixel 1013 and the target pixel y axis and the second separation distance on the vertical axis (y axis) using the planar orthogonal coordinate system of the reference pixel substantially corresponding to the center point in the second image display region and the planar orthogonal coordinate system of the target pixel. The image projection apparatus 100 may obtain information about the pixel coordinate system of the target pixel by reflecting a specific weight to each of the first separation distance and the second separation distance. The image projection apparatus 100 may determine the specific weight based on a screen-to-image ratio.

In operation 550, the image projection apparatus 100 may convert the output image 403 generated by correcting the input image 401 into an optical signal 405, and transmit the converted optical signal 405 to be displayed in the second image display region 641 provided on the projection plane 720 (640).

FIG. 7 is a view illustrating an operation of obtaining position data of pixel projection points (e.g., the pixel projection points 607 of FIG. 6) for projection screen modeling (e.g., the projection screen modeling 520, 601 of FIG. 5 or 6) according to an embodiment.

In FIG. 7, the coordinate plane 700 by the x- and z-axes is illustrated to facilitate the description of the separation distance 750, 760, 770 from the image projection apparatus (e.g., the image projection apparatus 100 of FIG. 1). Here, the x-axis and the z-axis are based on the space orthogonal coordinates illustrated in FIG. 1. The separation distance 750, 760, 770 illustrated in FIG. 7 may be referred to as a ‘depth value’ or a ‘z value’.

Referring to FIG. 7, the actual sensing measurement points 703 and/or actual pixel projection points 707 may be distributed and disposed on the projection plane 720 (e.g., the projection plane 110 of FIG. 1) (hereinafter referred to as the actual projection plane 720). This may refer to a partially enlarged view 740 of the actual projection plane 720.

According to an example, assuming that the position of the image projection apparatus 100 is fixed, the actual sensing measurement points 703 may be points where the beams (hereinafter referred to as “sensing beams”) of the signal (e.g., IR signal) transmitted by the distance sensor (e.g., the distance sensor 420 of FIG. 4) at substantially the same position as the image projection apparatus 100 arrive at the first specific area (e.g., the projection region 120 of FIG. 1). The first specific area may be provided on the actual projection plane 720. In the disclosure, since it is assumed that the actual projection plane 720 is non-planar, the actual sensing measurement points 703 may be distributed and disposed on the spatial coordinate corresponding to the first specific area. Therefore, the image projection apparatus 100 may obtain position data (hereinafter referred to as ‘first position data’) of actual sensing measurement points 703 that may be defined as space orthogonal coordinates system based on the sensing data of the distance sensor 420. For example, the z value in the space orthogonal coordinate system, which is the first position data, may be an actual sensing depth value 750 (hereinafter, referred to as a ‘first depth value 750’) corresponding to the vertical separation distance from the image projection apparatus 100 to the target sensing measurement point. Therefore, obtaining the first position data may mean obtaining the respective first depth values 750 of the actual sensing measurement points 703.

According to an example, assuming that the position of the image projection apparatus 100 is fixed, the actual pixel projection points 707 may be points where pixels projected as optical signals will arrive a specific area to display a screen in the second specific area (e.g., the image display region 130 of FIG. 1) in the image projection apparatus 100. The second specific area may be provided on the actual projection plane 720. In the disclosure, since it is assumed that the actual projection plane 720 is non-planar, the actual pixel projection points 707 may be distributed and disposed on the spatial coordinate corresponding to the second specific area. Therefore, the image projection apparatus 100 should be able to model the projection screen reflecting the curvature characteristic of the actual projection plane 720 in order to display the planar screen on the non-planar actual projection plane 720. For example, in order to detect the curvature characteristic of the actual projection plane 720, the image projection apparatus 100 should be able to obtain position data (hereinafter referred to as ‘the second position data’) of the actual pixel projection points 707. The second position data may be the space orthogonal coordinate system of the actual pixel projection points 707 on the spatial coordinate corresponding to the actual projection plane 720. For example, the z value in the space orthogonal coordinate system, which is the second position data, may be an actual projection depth value 770 (hereinafter referred to as a ‘second depth value 770’) corresponding to the vertical separation distance from the image projection apparatus 100 to the target pixel projection point. Therefore, in order to obtain the second position data, the respective second depth values 770 of the actual pixel projection points 707 should be obtained. For example, the second depth values 770 may be determined by performing a predetermined interpolation operation using the first depth values 750. For example, as the interpolation technique of predicting the space orthogonal coordinate system of the second positions, which are the peripheral positions of the first positions, using the space orthogonal coordinate system of the first positions, the interpolation technique in general spatial coordinates may be equally applied.

According to an example, the optical signal to be transmitted by the image projection apparatus 100 may be a set of beams 709 (hereinafter, referred to as projection beams 709) corresponding to pixels to display a screen on the actual projection plane 720. The projection beams 709 may reach the actual pixel projection points 707 of the actual projection plane 720 to display pixels to constitute a screen. When it is assumed that the position of the image projection apparatus 100 is fixed, the projection beams 709 may have a fixed direction (hereinafter, referred to as a ‘projection beam direction’). The projection beam direction may be defined as a projection direction vector. In this case, the position where the projection beams 709 pass through the virtual projection plane 710 spaced apart from the image projection apparatus 100 by a predetermined distance 760 may be fixed. The position where the projection beams 709 pass through the virtual projection plane 710 may be position data (hereinafter, referred to as ‘third position data’) of the virtual pixel projection points 705. For example, the third position data may be set through one measurement when the image projection apparatus 100 is installed. For example, the third position data may be set by an experimental value in the production process of the image projection apparatus 100. For example, the virtual projection plane 710 may be assumed as a plane having a z value of 1 in the coordinate plane 700. Virtual pixel projection points 705 may be distributed and disposed on the virtual projection plane 710. The projection direction vectors may pass through the virtual pixel projection points 705 on the virtual projection plane 710. For this, the partially enlarged view 730 of the virtual projection plane 710 may be referred to.

According to an example, the IR signal to be transmitted by the distance sensor 420 may be a set of sensing beams to reach the actual sensing measurement points 703 of the actual projection plane 720. The sensing beams may reach the actual sensing measurement points 703 of the actual projection plane 720. When it is assumed that the position of the image projection apparatus 100 is fixed, the sensing beams may have a fixed direction (hereinafter referred to as ‘sensing beam direction’). The sensing beam direction may be defined as a sensing direction vector. In this case, the position (e.g., the virtual sensing measurement points 701) where the sensing beams pass through the virtual projection plane 710 spaced apart from the image projection apparatus 100 by a predetermined distance 760 may be fixed. For example, the virtual projection plane 710 may be assumed as a plane having a z value of 1 in the coordinate plane 700. Virtual sensing measurement points 701 may be distributed and disposed on the virtual projection plane 710. The sensing direction vectors may pass through the virtual sensing measurement points 701 on the virtual projection plane 710. For this, the partially enlarged view 730 of the virtual projection plane 710 may be referred to.

Equation 1 below defines an example of determining the second position data D_{P2} by the third position data D_{P3} and the first depth value V_{D1}.

$${D}_{P 2} = {D}_{P 3} \times {V}_{D 1} \qquad [ Equation 1 ]$$

Here, the third position data D_{P3} may be set considering the characteristic of the image projection apparatus 100, or may be set in advance through actual measurement, and the first depth value V_{D1} may be changed by the curvature characteristic of the projection plane 720, so that the value actually measured may be used as necessary. For example, the first depth value V_{D1} may be measured in response to the user's request. For example, the first depth value V_{D1} may be measured when the power of the image projection apparatus 100 is supplied. For example, the first depth value V_{D1} may be periodically measured by a preset period in a state in which power is supplied.

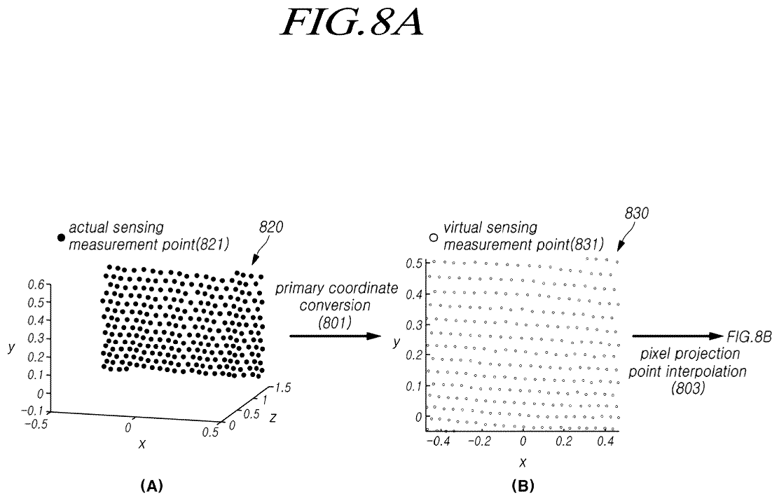

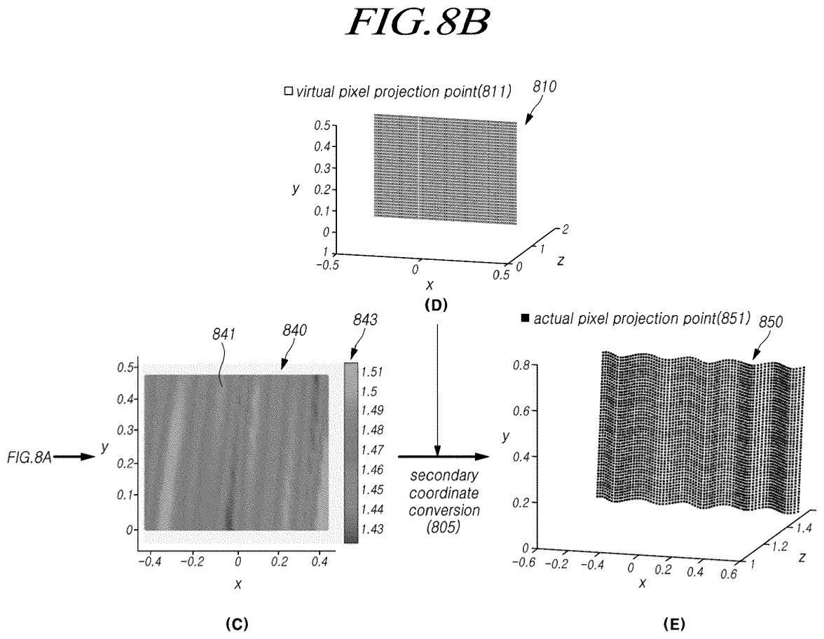

FIGS. 8A and 8B are a views illustrating projection screen modeling (e.g., the projection screen modeling operation 520, 601 of FIG. 5 or 6) step by step according to various embodiments.

Referring to FIG. 8A or FIG. 8B, the image projection apparatus 100 may obtain first position data, which is position data of actual sensing measurement points 821 (e.g., the actual sensing measurement points 703 of FIG. 7), using sensing data measured by a distance sensor (e.g., the distance sensor 420 of FIG. 4) that is present substantially at the same position (see (A)). The first position data may be the x value, the y value, and the z value corresponding to the space orthogonal coordinate system indicating the position of the actual sensing measurement points 821 in the spatial coordinate 820. In this case, the corresponding space orthogonal coordinate system may be represented as ‘P(x, y, z)’. The first position data may be obtained using the direction vector of the sensing beam transmitted by the distance sensor 420 and the distance from the distance sensor 420 to the corresponding sensing measurement point. For example, the image projection apparatus 100 may measure the time when the IR signal is transmitted by the distance sensor 420 and the time when the transmitted IR signal is reflected from the actual sensing measurement points 821 distributed in the first specific area (e.g., the projection region 120 of FIG. 1), and the delay time calculated based thereon may be considered to determine the first depth value (z value) (e.g., the first depth value 750 of FIG. 7).

The image projection apparatus 100 may perform primary coordinate conversion 801 (see (B) in FIG. 8A). For example, the image projection apparatus 100 may perform the primary coordinate conversion 801 to obtain position data (hereinafter referred to as ‘fourth position data’) of virtual sensing measurement points 831 (e.g., the virtual sensing measurement points 701 of FIG. 7) on the virtual projection plane (e.g., 710 of FIG. 7) corresponding to the planar coordinate 830 using the first position data. The fourth position data may be the x′ value and the y′ value corresponding to the planar orthogonal coordinate system indicating the position of the virtual sensing measurement points 831 in the planar coordinate 830. In this case, the corresponding planar orthogonal coordinate system may be represented as ‘P’(x′, y′)′.

Equation 2 below defines an example of determining the fourth position data P′(x′, y′) by the first position data P(x, y, z).

$${x}^{′} = x / z \qquad [ Equation 2 ]$$

$${y}^{′} = y / z$$

The image projection apparatus 100 may perform a predetermined pixel projection point interpolation operation 803 using the first depth values 750. The image projection apparatus 100 may determine the second depth values (z′) 841 (e.g., the second depth value 770 of FIG. 7) by the predetermined pixel projection point interpolation operation 803 (see (C)). The second depth value 770 may be a depth value for actual pixel projection points (e.g., the actual pixel projection points 707 of FIG. 7) on the actual projection plane (e.g., the actual projection plane 720 of FIG. 7) corresponding to the spatial coordinate 840. The identifier 843 illustrated on the right side of the spatial coordinate 840 is for showing the degree of the second depth values (z′) 841. For example, as the interpolation technique of predicting the space orthogonal coordinate system of the second positions, which are the peripheral positions of the first positions, using the space orthogonal coordinate system of the first positions on the actual projection plane (720), the interpolation technique in general spatial coordinates may be equally applied. According to an example, the image projection apparatus 100 may determine an interpolation weight for interpolation of the second depth value of the corresponding pixel projection point to be interpolated based on the fourth position data P′(x′, y′). For example, the image projection apparatus 100 may give a relatively high weight to the virtual sensing projection point positioned close to the virtual projection plane 710 based on the fourth position data P′(x′, y′).

The image projection apparatus 100 may perform secondary coordinate conversion 805 using the second depth values (z′) 841 and the third position data P″(x″, y″). The third position data may be position data of the virtual pixel projection points 811 (e.g., the virtual pixel projection points 705 of FIG. 7) on the virtual projection plane (e.g., 710 of FIG. 7) corresponding to the planar coordinate 810 (see (D)). For example, the virtual projection plane 710 may be assumed as a coordinate plane having a z value of 1. The third position data may include information about the position where projection beams (e.g., the projection beams 709 of FIG. 7) pass through the virtual projection plane 710 corresponding to the planar coordinates 810. For example, the third position data may be position data of virtual pixel projection points (e.g., the virtual pixel projection points 705 of FIG. 7) distributed and disposed on the virtual projection plane 710. For example, the third position data may be preset or set through one measurement when the image projection apparatus 100 is installed. For example, the third position data may be preset by an experimental value in the production process of the image projection apparatus 100. For example, after projecting an optical signal to the front at a distance of 1 meter, the image projection apparatus 100 may obtain third position data as coordinates of each pixel constituting the displayed screen.

According to an example, the image projection apparatus 100 may perform a secondary coordinate conversion 805 for obtaining the second position data P″′(x″′, y″′, and z′) using the second depth values (z′) 841 and the third position data P″(x″, y″) (see (E)). The second position data may be the x″′ value, y″′ value, and z′ value corresponding to the space orthogonal coordinate system indicating the position of the actual pixel projection points 707 in the spatial coordinates 850.

Equation 3 below defines an example of determining the second position data P″′(x″′, y″′, z′) that is the position data of the actual pixel projection points 707 based on the third position data P″(x″, y″) and the second depth values (z′) 841.

$${x}^{′″} = {x}^{″} \cdot {z}^{′} \qquad [ Equation 3 ]$$

$${y}^{′″} = {y}^{″} \cdot {z}^{′}$$

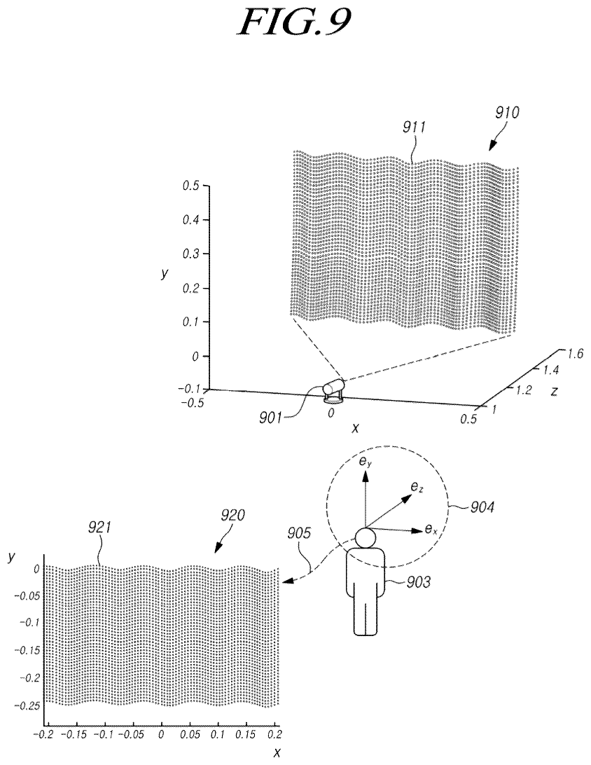

FIG. 9 is a view illustrating a viewpoint conversion operation (e.g., viewpoint conversion 530, 602 of FIG. 5 or 6) of converting a projection region (e.g., the projection region 120 of FIG. 1) based on a viewpoint of a viewer (e.g., the viewer 103 of FIG. 1) according to an embodiment.

Referring to FIG. 9, an image projection apparatus 901 (e.g., the image projection apparatus 100 of FIG. 1) may perform a viewpoint conversion operation. The image projection apparatus 901 may obtain a pixel coordinate system 921 by performing the viewpoint conversion operation. The obtained pixel coordinate system 921 may be a planar coordinate system for allowing a screen to be displayed in a non-planar image display region (e.g., the image display region 130 of FIG. 1) to be viewed as a planar screen at the viewpoint where actual viewing is performed. For example, the viewpoint conversion operation may perform an operation of converting the pixel coordinate system 911 at the viewpoint 904 (hereinafter referred to as a ‘first viewpoint 904’) of the image projection apparatus 901 to the pixel coordinate system 921 at the viewer 903's viewpoint 905 (hereinafter referred to as a ‘second viewpoint 905’), for the projection plane (e.g., the projection plane 110 of FIG. 1). In other words, the image projection apparatus 901 may convert the first pixel coordinate system 911 (e.g., the second position data of FIG. 8) obtained based on the first viewpoint 904 into the second pixel coordinate system 921 based on the second viewpoint 905. The first pixel coordinate system 911 may be the space orthogonal coordinate system in spatial coordinates 910. The second pixel coordinate system 921 may be the planar orthogonal coordinate system in planar coordinates 920. As described above, the image projection apparatus 901 may generate viewpoint-converted image data in response to a change in viewpoint.

According to an example, the image projection apparatus 901 may convert the first pixel coordinate system (x, y, z) 911 obtained at the first viewpoint 904 into the second pixel coordinate system (x_{view}, y_{view}, z_{view}) 921 by reflecting the position (x₀, y₀, z₀) of the viewer 903 and the second viewpoint (eₓ, e_{y}, e_{z}). The second pixel coordinate system (x_{view}, y_{view}, z_{view}) may correspond to the positions of pixels to be included in the image display region 130 viewed from the second viewpoint 905. For example, the first viewpoint 904 is defined as (pₓ, p_{y}, p_{z}), pₓ=[1 0 0], p_{y}=[0 1 0], p_{z}=[0 0 1].

Equation 4 below defines an example of determining the second pixel coordinate system (x_{view}, y_{view}, z_{view}) 921 by performing viewpoint conversion on the first pixel coordinate system (x, y, z) 911.

$$[ \begin{matrix}{x}_{view} \\ {y}_{view} \\ {z}_{view}\end{matrix} ] = [ \begin{matrix}{e}_{x} \\ {e}_{y} \\ {e}_{z}\end{matrix} ] ( [ \begin{matrix}x \\ y \\ z\end{matrix} ] - [ \begin{matrix}{x}_{0} \\ {y}_{0} \\ {z}_{0}\end{matrix} ] ) \qquad [ Equation 4 ]$$

According to an example, the image projection apparatus 901 may convert the second pixel coordinate system (x_{view}, y_{view}, z_{view}) 921 obtained by reflecting the position of the viewer 903 and the second view point 905 into the planar orthogonal coordinate system of the planar coordinate 920. The image projection apparatus 100 may obtain the planar orthogonal coordinate system by projecting the second pixel coordinate system (x_{view}, y_{view}, z_{view}) 921 onto the planar coordinate 920. The planar orthogonal coordinate system may adjust the size of the pixel in proportion to the depth value z_{view} by applying perspective. In this case, a pixel having a large depth value may have a relatively smaller size than a pixel having a small depth value.

Equation 5 below defines an example of converting the space orthogonal coordinate system (x_{view}, y_{view}, z_{view}) 921 of spatial coordinates into the planar orthogonal coordinate system (x_{screen}, y_{screen}) of the planar coordinate 920 considering the depth value Z_{view}.

$${x}_{s c r e e n} = {x}_{v i e w} / {z}_{v i e w} \qquad [ Equation 5 ]$$

$${y}_{s c r e e n} = {y}_{v i e w} / {z}_{v i e w}$$

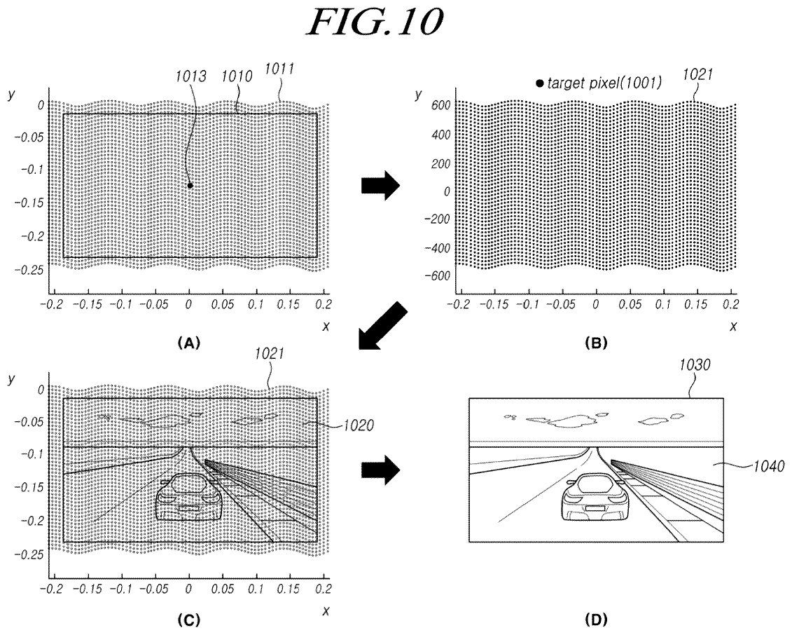

FIG. 10 is a view illustrating an image correction operation (e.g., image correction 540, 603 of FIG. 5 or 6).

Referring to FIG. 10, the image projection apparatus 100 may correct the input image (e.g., the input image 401 of FIG. 4) based on the obtained information about the first planar orthogonal coordinate system 1011 (e.g., the planar orthogonal coordinate system 921 (x_{screen}, y_{screen})) considering the occurrence of distortion due to the curvature characteristic of the projection region (e.g., the projection region 120 of FIG. 1), generating an output image 1040 (e.g., the output image 403 of FIG. 4).

According to an example, the image projection apparatus 100 may convert the first planar orthogonal coordinate system 1011 (x_{screen}, y_{screen}) into an image coordinate system 1021 (x_{image}, y_{image}) ((A)→(B)). The first planar orthogonal coordinate system 1011 (x_{screen}, y_{screen}) is a screen coordinate in a unit length (e.g., 1 meter). The image coordinate system 1021 (x_{image}, y_{image}) is a pixel coordinate in pixels. For example, when the resolution of the input image 401 is 1920×1080, a rectangle with the largest ratio of 16:9 inside the screen is obtained.

According to an example, the image projection apparatus 100 may obtain information about the pixel coordinate system 1021 of the target pixel 1001. The image projection apparatus 100 may obtain information about the pixel coordinate system 1021 of the target pixel 1001 by reflecting a specific weight to the separation distance between the reference pixel 1013 and the target pixel 1001 based on the information about the first planar orthogonal coordinate system 1011. The reference pixel 1013 may be a pixel substantially positioned at the center point in the image display region.

For example, the image projection apparatus 100 may obtain a first separation distance (x_{screen}−x_{center}) on the horizontal axis (x-axis) and a second separation distance (y_{screen}−y_{center}) on the vertical axis (y-axis) between the reference pixel 1013 and the target pixel 1001 using the planar orthogonal coordinate system of the reference pixel 1013 and the planar orthogonal coordinate system of the target pixel 1001 based on the information about the first planar orthogonal coordinate system 1011. The image projection apparatus 100 may obtain information about the pixel coordinate system (x_{image}, y_{image}) of the target pixel 1001 by reflecting the specific weight λ to each of the first separation distance (x_{screen}−x_{center}) and the second separation distance (y_{screen}−y_{center}).

Equation 6 below defines an example of obtaining the pixel coordinate system (x_{image}, y_{image}) of the target pixel 1001 by reflecting the specific weight λ to the first separation distance (x_{screen}−x_{center}) and the second separation distance (y_{screen}−y_{center}).

$${x}_{i m a g e} = λ ( {x}_{s c r e e n} - {x}_{center} ) \qquad [ Equation 6 ]$$

$${y}_{i m a g e} = λ ( {y}_{s c r e e n} - {y}_{center} )$$

The image projection apparatus 100 may determine the specific weight λ based on a screen-to-image ratio. In this case, as the screen-to-image ratio increases, the image may be displayed in a smaller sizer as compared with the screen.

The image projection apparatus 100 may warp the input image 1020 based on the information 1021 about the pixel coordinate system (x_{image}, y_{image}) ((B)→(C)). For example, the image projection apparatus 100 may generate an output image 403 obtained by correcting the pixel values of the input image 401 using the information 1021 about pixel coordinate system (x_{image}, y_{image}).

Equation 7 below defines an example of replacing the (x_{image}(i), y_{image}(i)) pixel value of the input image 401 with the (i, j) pixel value of the output image 403.

$$out ( i , j ) = in ( {x}_{image} ( i ) , {y}_{image} ( j ) ) \qquad [ Equation 7 ]$$

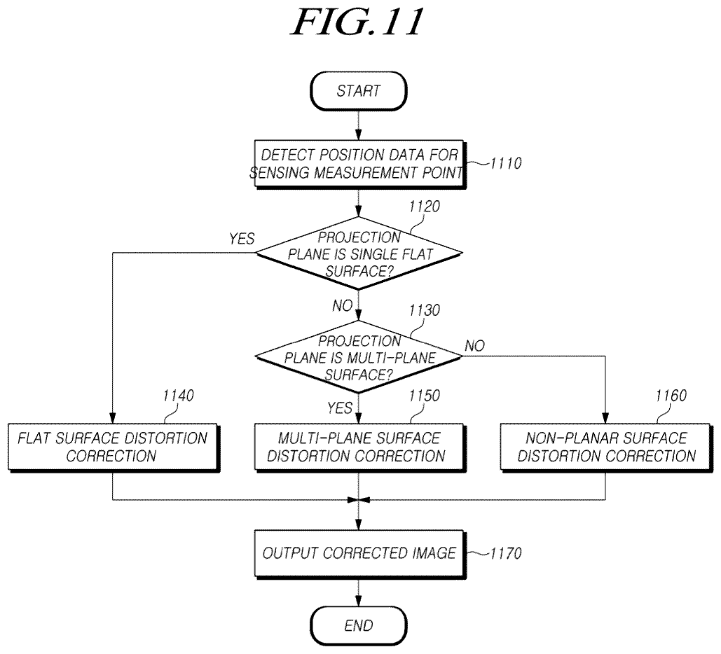

FIG. 11 is a flowchart illustrating control for performing image correction in an image projection apparatus (e.g., the image projection apparatus 100 of FIG. 1) according to an embodiment.

Referring to FIG. 11, in operation 1110, the image projection apparatus 100 may detect position data for sensing measurement points. According to an example, the image projection apparatus 100 may obtain position data for sensing measurement points (e.g., the sensing measurement points 605 of FIG. 6) distributed in the projection region (e.g., the projection region 120 of FIG. 1) of the projection plane (e.g., the projection plane 110 of FIG. 1) using a distance sensor (e.g., the distance sensor 420 of FIG. 4). For example, the distance sensor 420 may transmit the infrared signal toward the projection plane 110 and receive the infrared signal reflected from the sensing measurement points of the projection plane 110 to obtain the coordinate values respectively corresponding to the sensing measurement points as position data. When the projection plane 110 is non-planar, the coordinate value obtained by the distance sensor 420 may be the space orthogonal coordinate system.

The image projection apparatus 100 may analyze the position data obtained for the projection plane 110 (or the projection region 120) to obtain information about the curvature characteristic of the projection plane 110 (or the projection region 120). The information about the curvature characteristic obtained by the image projection apparatus 100 may include information for determining whether the projection plane 110 (or the projection region 120) is a flat surface, a multi-plane surface, or a non-planar surface. For example, the information about the curvature characteristic may include information related to the inclination, inclination direction, or curvature of the projection plane 110 (or the projection region 120) that the image projection apparatus 100 may reference to identify the shape of the projection plane 110 (or the projection region 120).

When analyzing information about the curvature characteristic, the image projection apparatus 100 may determine whether the projection plane 110 (or the projection region 120) is a single flat surface, a multi-plane surface, or a non-planar surface in operation 1120 or operation 1130.

In operation 1120, the image projection apparatus 100 may determine whether the projection plane 110 (or the projection region 120) is a single flat surface. In operation 1130, the image projection apparatus 100 may determine whether the projection plane 110 (or the projection region 120) is a multi-plane surface. For example, if the image projection apparatus 100 determines that the projection plane 100 (or the projection region 120) is a single flat surface, in operation 1140, the image projection apparatus 100 may perform flat surface distortion correction on the input image. When the image projection apparatus 100 determines that the projection plane 100 (or the projection region 120) is a multi-plane surface, in operation 1150, the image projection apparatus 100 may perform multi-plane surface distortion correction on the input image. When the image projection apparatus 100 determines that the projection plane 100 (or the projection region 120) is a non-planar surface, in operation 1160, the image projection apparatus 100 may perform non-planar surface distortion correction on the input image. In the drawings, it is assumed that the projection plane 110 (or the projection region 120) is a single flat surface, a multi-plane surface, or a non-planar surface, but the same may be used for other applied types of projection planes.

When distortion correction for the input image is completed by a specific distortion correction method, the image projection apparatus 100 may convert the output image generated by distortion correction into an optical signal in operation 1170, and transmit the converted optical signal toward the projection plane 110 (or the projection region 120).

FIG. 12A is an example view illustrating displaying an image on a single flat surface by flat surface distortion correction according to an embodiment. FIG. 12B is an example view illustrating an image displayed on a multi-plane surface by multi-plane surface distortion correction according to an embodiment. FIG. 12C is an example view illustrating displaying an image on a non-planar surface by non-planar surface distortion correction according to an embodiment.

Referring to FIG. 12A, the image projection apparatus (e.g., the image projection apparatus 100 of FIG. 1) may project an output image generated by performing flat surface distortion correction on the projection plane 1211 (or projection region) which is a flat surface, as an optical signal, onto the projection plane 1211 (or the projection region). In this case, the output image may be provided as a flat screen on the single flat surface corresponding to the projection plane 1211 (1213).

Referring to FIG. 12B, the image projection apparatus 100 may project an output image generated by performing multi-plane surface distortion correction on the projection plane 1221 (or projection region), which is a multi-plane surface, as an optical signal, onto the projection plane 1221 (or the projection region). In this case, the output image may be provided as a flat screen on the multi-plane surface corresponding to the projection plane 1221 (1223).

Referring to FIG. 12C, the image projection apparatus 100 may project an output image generated by performing non-planar surface distortion correction on the non-planar projection plane 1231 (or projection region), as an optical signal, onto the projection plane 1231 (or the projection region). In this case, the output image may be provided as a flat screen on the non-planar surface corresponding to the projection plane 1231 (1233).

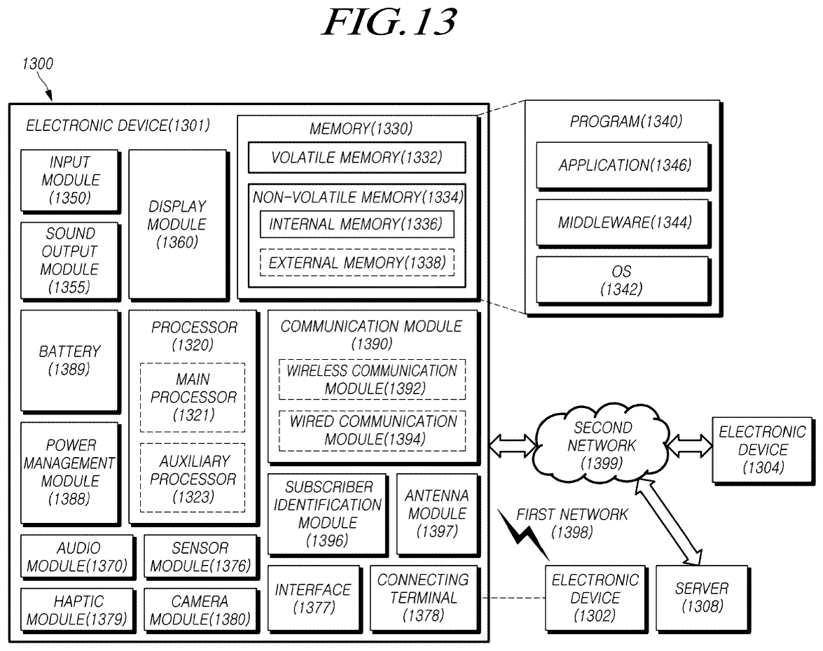

FIG. 13 is a block diagram illustrating an electronic device 1301 (e.g., the image projection apparatus 130 of FIG. 2) in a network environment 1300 according to various embodiments.

Referring to FIG. 13, the electronic device 1301 in the network environment 1300 may communicate with at least one of an electronic device 1303 via a first network 1398 (e.g., a short-range wireless communication network), or an electronic device 1305 or a server 1307 via a second network 1396 (e.g., a long-range wireless communication network). According to an example, the electronic device 1301 may communicate with the electronic device 1305 via the server 1307. According to an example, the electronic device 1301 may include a processor 1310, memory 1320, a sound module 1340, an image module 1350, a sensor module 1360, a power management module 1370, an input module 1382, an interface 1384, a connecting terminal 1386, or a communication module 1390. In an example, at least one (e.g., the input module 1382) of the components may be omitted from the electronic device 1301, or one or more other components may be added in the electronic device 101. In an example, some of these components may be integrated into one component.

The processor 1310 may execute, for example, software (e.g., a program 1330) to control at least one other component (e.g., a hardware or software component) of the electronic device 1301 coupled with the processor 1310, and may perform various data processing or computation. According to an example, as at least part of the data processing or computation, the processor 1310 may store a command or data received from another component (e.g., the sensor module 1360 or the communication module 1390) in volatile memory 1322, process the command or the data stored in the volatile memory 1322, and store resulting data in non-volatile memory 1324. According to an example, the processor 1310 may include a main processor 1312 (e.g., a central processing unit (CPU) or an application processor (AP)), or an auxiliary processor 1314 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 1301 includes the main processor 1312 and the auxiliary processor 1314, the auxiliary processor 1314 may be configured to use lower power than the main processor 1312 or to be specified for a designated function. The auxiliary processor 1314 may be implemented as separate from, or as part of the main processor 1312.

The auxiliary processor 1314 may control at least some of functions or states related to at least one component (e.g., the sensor module 1360 or the communication module 1390) among the components of the electronic device 1301, instead of the main processor 1312 while the main processor 1312 is in an inactive (e.g., sleep) state, or together with the main processor 1312 while the main processor 1312 is in an active state (e.g., executing an application). According to an example, the auxiliary processor 1314 (e.g., an image signal processor or a communication processor) may be implemented as part of another component (e.g., the communication module 1390) functionally related to the auxiliary processor 123. According to an example, the auxiliary processor 1314 (e.g., the neural processing unit) may include a hardware structure specified for artificial intelligence model processing. The artificial intelligence model may be generated via machine learning. Such learning may be performed by the electronic device 1301 where the artificial intelligence is performed or via a separate server (e.g., the server 1307). Learning algorithms may include, but are not limited to supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1320 may store various data used by at least one component (e.g., the processor 1310 or the sensor module 1360) of the electronic device 1301. The various data may include, for example, software (e.g., the program 1330) and input data or output data for a command related thereto. The memory 1320 may include the volatile memory 1322 or the non-volatile memory 1324.

The program 1330 may be stored in the memory 1320 as software, and may include, for example, an operating system (OS) 1336, middleware 1334, or an application 1332.

The input module 1382 may receive a command or data to be used by other component (e.g., the processor 1310) of the electronic device 1301, from the outside (e.g., a user) of the electronic device 1301. The input module 1382 may include, for example, a microphone, a mouse, a keyboard, keys (e.g., buttons), or a digital pen (e.g., a stylus pen).

The sound module 1340 may include a sound processing module 1342 or a sound output module 1344. The sound output module 1344 may output audio signals to the outside of the electronic device 1301. The sound output module 1344 may include a speaker. The speaker may be used for general purposes, such as playing multimedia or playing record. The sound processing module 1342 may convert a sound into an electrical signal and vice versa. According to an example, the sound module 1340 may obtain the sound via the input module 1382, or output the sound via the sound output module 1344 or a headphone of an external electronic device (e.g., the electronic device 1303) directly (e.g., wiredly) or wirelessly coupled with the electronic device 1301.

The image module 1350 may include an image processing module 1352 or an image output module 1354. The image processing module 1352 may output video signals to the outside of the electronic device 1301. The video output module 1354 may include a display and/or a light projector. The light projector may convert electrical video signals into optical signals and output them. The image processing module 1352 may convert an image into an electrical signal, or may convert an electrical signal into an image. According to an example, the image module 1350 may obtain the image through the input module 1382, or output the image through the image output module 1354 or an external electronic device (e.g., the electronic device 1303) directly or wirelessly connected with the electronic device 1301. The image module 1350 may include, for example, a display, a hologram device, or a projector and control circuitry to control a corresponding one of the display, hologram device, and projector.

The sensor module 1360 may detect an operational state (e.g., power or temperature) of the electronic device 1301 or an environmental state (e.g., a state of a user) external to the electronic device 1301, and then generate an electrical signal or data value corresponding to the detected state. According to an example, the sensor module 1360 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1384 may support one or more specified protocols to be used for the electronic device 1301 to be coupled with the external electronic device (e.g., the electronic device 1303) directly (e.g., wiredly) or wirelessly. The interface 1384 may include a high definition multimedia interface (HDMI), a universal serial bus (USB) interface, a secure digital (SD) card interface, or an audio interface (e.g., Bixby).

A connecting terminal 1386 may include a connector via which the electronic device 1301 may be physically connected with the external electronic device (e.g., the electronic device 1303). According to an example, the connecting terminal 1386 may include, for example, a HDMI connector, a USB connector, a SD card connector, or an audio connector (e.g., a headphone connector).

The power management module 1370 may manage power supplied to the electronic device 1301. According to an embodiment, the power management module 1370 may be implemented as at least part of, for example, a power management integrated circuit (PMIC).

The communication module 1390 may support establishing a direct (e.g., wired) communication channel or a wireless communication channel between the electronic device 1301 and the external electronic device (e.g., the electronic device 1303, the electronic device 1305, or the server 1307) and performing communication via the established communication channel. The communication module 1390 may include one or more communication processors that are operable independently from the processor 1310 (e.g., the application processor (AP)) and supports a direct (e.g., wired) communication or a wireless communication. According to an example, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device 1305 via a first network 1398 (e.g., a short-range communication network, such as BluetoothT, wireless-fidelity (Wi-Fi) direct, or infrared data association (IrDA)) or a second network 1396 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 1392 may identify or authenticate the electronic device 1301 in a communication network, such as the first network 1398 or the second network 1396, using subscriber information (e.g., international mobile subscriber identity (IMSI)).

The wireless communication module 1392 may support a 5G network, after a 4G network, and next-generation communication technology new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., the mmWave band) to achieve a high data transmission rate. The wireless communication module 1392 may support various technologies for securing performance on a high-frequency band, such as beamforming, massive multiple-input and multiple-output (massive MIMO), full dimensional MIMO (FD-MIMO), array antenna, analog beam-forming, or large scale antenna. The wireless communication module 1392 may support various requirements specified in the electronic device 1301, an external electronic device (e.g., the electronic device 1305), or a network system (e.g., the second network 1396). According to an embodiment, the wireless communication module 1392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the electronic device 1301 and the external electronic device 1305 via the server 1307 coupled with the second network 1396. The external electronic devices 1303 or 1305 each may be a device of the same or a different type from the electronic device 1301. According to an example, all or some of operations to be executed at the electronic device 1301 may be executed at one or more of the external electronic devices 1303, 1305, or 1307. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, mobile edge computing (MEC), or client-server computing technology may be used, for example. The electronic device 1301 may provide ultra low-latency services using distributed computing or mobile edge computing. In an embodiment, the external electronic device 1305 may include an internet-of-things (IoT) device. The server 1307 may be an intelligent server using machine learning and/or a neural network. According to an example, the external electronic device 1305 or the server 1307 may be included in the second network 1396. The electronic device 1301 may be applied to intelligent services (e.g., smart home, smart city, smart car, or health-care) based on 5G communication technology or IoT-related technology.

According to an example, the image projection apparatus 100 may comprise at least one sensor (ToF) 420. The image projection apparatus 100 may include an image projector 440. The image projection apparatus 100 may comprise at least one memory 430 including a non-volatile storage medium storing instructions. The image projection apparatus 100 may comprise at least one processor 410 including a processing circuit. When executed individually or collectively by the at least one processor 410, the instructions may cause the image projection apparatus 100 to perform at least one operation. The at least one operation may comprise modeling 601 a first image display region 620 to reflect a curvature characteristic of a projection plane 110 based on sensing data of the at least one sensor 420. The at least one operation may comprise obtaining 602 second position information about second pixel projection points 609 to be included in a second image display region 630 considering a viewpoint for viewing the projection plane 110, based on first position information about first pixel projection points 607 included in the modeled first image display region 620. The at least one operation may comprise generating 603 an output image 403 to be projected as an optical signal 405 by the image projector 440 by correcting an input image 401 based on the obtained second position information, considering an occurrence of distortion due to the curvature characteristic.

According to an example, when executed individually or collectively by the at least one processor 410, the instructions may cause the image projection apparatus 100 to obtain a first depth value 750 of actual sensing measurement points 703 included in the projection plane 720 by the at least one sensor 420.

According to an example, when executed individually or collectively by the at least one processor 410, the instructions may cause the image projection apparatus 100 to obtain the first position information about the first pixel projection points 707, which are the actual pixel projection points in the projection plane 720, based on the obtained first depth value 750 and third position information about third pixel projection points 705 included in a virtual projection plane 710.

According to an example, the first position information may be information about a position in a space orthogonal coordinate system, and the second and third position information may be information about a position in a planar orthogonal coordinate system.

According to an example, when executed individually or collectively by the at least one processor 410, the instructions may cause the image projection apparatus 100 to perform 801, 803 interpolation using the obtained first depth value 750 to obtain a second depth value 760 of the first pixel projection points 707.

According to an example, when executed individually or collectively by the at least one processor 410, the instructions may cause the image projection apparatus 100 to obtain 805 the first position information by applying the obtained second depth value 760 to the third position information.

According to an example, when executed individually or collectively by the at least one processor 410, the instructions may cause the image projection apparatus 100 to convert a first space orthogonal coordinate system of the first pixel projection points into a second space orthogonal coordinate system of the second pixel projection points with respect to the viewpoint 904.

According to an example, when executed individually or collectively by the at least one processor 410, the instructions may cause the image projection apparatus 100 to project the second space orthogonal coordinate system onto a coordinate plane to obtain the second position information.

According to an example, when executed individually or collectively by the at least one processor 410, the instructions may cause the image projection apparatus 100 to generate the output image by correcting the input image so that a size of a target pixel value to be projected based on the second position information is inversely proportional to a depth value corresponding to the target pixel value in the second space orthogonal coordinate system 920.

According to an example, when executed individually or collectively by the at least one processor 410, the instructions may cause the image projection apparatus 100 to obtain information about a pixel coordinate system 1021 of a target pixel by reflecting the specific weight to a separation distance between a reference pixel 1013 corresponding to a substantial center point in the second image display region 1010 and the target pixel based on the second position information.

According to an example, when executed individually or collectively by the at least one processor 410, the instructions may cause the image projection apparatus 100 to obtain a first separation distance in a horizontal axis x-axis and a second separation distance in a vertical axis y-axis between a reference pixel 1013 and a target pixel using a planar orthogonal coordinate system of the reference pixel 1013 corresponding to a substantial center point in the second image display region 1010 and a planar orthogonal coordinate system of the target pixel based on the second position information.

According to an example, when executed individually or collectively by the at least one processor 410, the instructions may cause the image projection apparatus 100 to obtain information about a pixel coordinate system 1021 of the target pixel by reflecting the specific weight in each of the first separation distance and the second separation distance.

According to an example, when executed individually or collectively by the at least one processor 410, the instructions may cause the image projection apparatus 100 to determine a specific weight based on a screen-to-image ratio.

According to an example, the virtual projection plane 710 may be a virtual plane facing the image projection apparatus 100 at a predetermined distance 760 toward the projection plane 720 from the image projection apparatus 100.

According to an example, when executed individually or collectively by the at least one processor 410, the instructions may cause the image projection apparatus 100 to preset the third position information considering the distance 760 between the image projection apparatus 100 and the virtual projection plane 710.

According to an example, when executed individually or collectively by the at least one processor 410, the instructions may cause the image projection apparatus 100 to obtain 1110 the curvature characteristic of the projection plane 720 based on the sensing data.

According to an example, when executed individually or collectively by the at least one processor 410, the instructions may cause the image projection apparatus 100 to, if it is determined that the projection plane is a flat surface based on the obtained curvature characteristic, generate 1120, 1140 the output image by performing planar distortion correction on the input image.

According to an example, when executed individually or collectively by the at least one processor 410, the instructions may cause the image projection apparatus 100 to, if it is determined that the projection plane is a multi-plane surface based on the obtained curvature characteristic, generate 1130, 1150 the output image by performing multi-plane distortion correction on the input image.

According to an example, when executed individually or collectively by the at least one processor 410, the instructions may cause the image projection apparatus 100 to, if it is determined that the projection plane is a curved surface based on the obtained curvature characteristic, generate 1130, 1160 the output image by performing curvature distortion correction on the input image.

According to an example, a method for operating an image projection apparatus 100 may comprise modeling 520 a first image display region 620 to reflect a curvature characteristic of a projection plane 110 based on sensing data of at least one sensor 420. The operation method may comprise obtaining 530 second position information about second pixel projection points 609 to be included in a second image display region 630 considering a viewpoint 904 for viewing the projection plane 110, based on first position information about first pixel projection points 607 included in the modeled first image display region 620. The operation method may comprise generating an output image 403 to be projected as an optical signal 405 by correcting an input image 401 based on the obtained second position information, considering an occurrence of distortion due to the curvature characteristic.

According to an example, modeling the first image display region may include obtaining a first depth value 750 of actual sensing measurement points 703 included in the projection plane 720 by the at least one sensor 420.

According to an example, modeling the first image display region may include obtaining the first position information about the first pixel projection points 707, which are the actual pixel projection points in the projection plane 720, based on the obtained first depth value 750 and third position information about third pixel projection points 705 included in a virtual projection plane 710.

According to an example, the first position information may be information about a position in a space orthogonal coordinate system, and the second and third position information may be information about a position in a planar orthogonal coordinate system.

According to an example, obtaining the information about the space orthogonal coordinate system may include performing 801, 803 interpolation using the obtained first depth value 750 to obtain a second depth value 760 of the first pixel projection points 707.

According to an example, obtaining the information about the space orthogonal coordinate system may include obtaining 805 the first position information by applying the obtained second depth value 760 to the third position information.

According to an example, obtaining the information about the first planar orthogonal coordinate system may include converting a first space orthogonal coordinate system of the first pixel projection points into a second space orthogonal coordinate system of the second pixel projection points with respect to the viewpoint 904.

According to an example, obtaining the information about the first planar orthogonal coordinate system may include projecting the second space orthogonal coordinate system onto a coordinate plane to obtain the second position information.

According to an example, generating the output image may include generating the output image by correcting the input image so that a size of a target pixel value to be projected based on the second position information is inversely proportional to a depth value corresponding to the target pixel value in the second space orthogonal coordinate system 920.

According to an example, generating the output image may include obtaining information about a pixel coordinate system 1021 of a target pixel by reflecting the specific weight to a separation distance between a reference pixel 1013 corresponding to a substantial center point in the second image display region 1010 and the target pixel based on the second position information.

According to an example, generating the output image may include obtaining a first separation distance in a horizontal axis x-axis and a second separation distance in a vertical axis y-axis between a reference pixel 1013 and a target pixel using a planar orthogonal coordinate system of the reference pixel 1013 corresponding to a substantial center point in the second image display region 1010 and a planar orthogonal coordinate system of the target pixel based on the second position information.

According to an example, generating the output image may include obtaining information about a pixel coordinate system 1021 of the target pixel by reflecting the specific weight in each of the first separation distance and the second separation distance.

According to an example, generating the output image may include determine a specific weight based on a screen-to-image ratio.

According to an example, the virtual projection plane 710 may be a virtual plane facing the image projection apparatus 100 at a predetermined distance 760 toward the projection plane 720 from the image projection apparatus 100.

According to an example, the operation method may comprise presetting or setting the third position information considering the distance 760 between the image projection apparatus 100 and the virtual projection plane 710.

According to an example, the operation method may comprise obtaining the curvature characteristic of the projection plane 720 based on the sensing data 1110. The operation method may comprise, if it is determined that the projection plane is a flat surface based on the obtained curvature characteristic, generating 1120, 1140 the output image by performing planar distortion correction on the input image. The operation method may comprise, if it is determined that the projection plane is a multi-plane surface based on the obtained curvature characteristic, generating 1130, 1150 the output image by performing multi-plane distortion correction on the input image. The operation method may comprise, if it is determined that the projection plane is a curved surface based on the obtained curvature characteristic, generating 1130, 1160 the output image by performing curvature distortion correction on the input image.

According to an example, there may be provided a storage medium storing computer-readable instructions. When executed by at least a portion of at least one processor included in the image projection apparatus 100, the instructions may cause the image projection apparatus (100) to perform at least one operation. The at least one operation may comprise modeling 520 a first image display region 620 to reflect a curvature characteristic of a projection plane 110 based on sensing data of the at least one sensor 420. The at least one operation may comprise obtaining 530 second position information about second pixel projection points 609 to be included in a second image display region 630 considering a viewpoint for viewing the projection plane 110, based on first position information about first pixel projection points 607 included in the modeled first image display region 620. The at least one operation may comprise generating an output image 403 to be projected as an optical signal 405 by correcting an input image 401 based on the obtained second position information, considering an occurrence of distortion due to the curvature characteristic.

The electronic device according to various embodiments may be one of various types of electronic devices. The electronic devices may include, for example, a display device (e.g., a TV, a monitor, or a light projection device), a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., the memory 430) that is readable by a machine (e.g., the image projection apparatus 100). For example, a processor (e.g., the processor 410) of the machine (e.g., the image projection apparatus 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An image projection apparatus, comprising:
at least one sensor;
an image projector;
at least one memory comprising a non-volatile storage medium storing instructions; and
at least one processor comprising processing circuitry,
wherein, when executed individually or collectively by the at least one processor, the instructions cause the image projection apparatus to:
model a first image display region including first pixel projection points according to a curvature characteristic of a projection plane based on sensing data of the at least one sensor;
obtain second position information about second pixel projection points included in a second image display region according to a viewpoint of the projection plane, based on first position information about the first pixel projection points; and
generate an output image including correct an input image based on the second position information, according to the curvature characteristic of the projection plane.

2. The image projection apparatus of claim 1, wherein, when executed individually or collectively by the at least one processor, the instructions further cause the image projection apparatus to:
obtain a first depth value of sensing measurement points included in the projection plane based on the sensing data of the at least one sensor; and
obtain the first position information about the first pixel projection points based on the first depth value, and obtain third position information about third pixel projection points included in a virtual projection plane, and
wherein the first position information comprises information about a position in a three-dimensional (3D) orthogonal coordinate system, and the second position information and the third position information respectively comprise information about a position in a planar orthogonal coordinate system.

3. The image projection apparatus of claim 2, wherein, when executed individually or collectively by the at least one processor, the instructions further cause the image projection apparatus to:
perform an interpolation using the first depth value to obtain a second depth value of the first pixel projection points; and
apply the second depth value to the third position information to obtain the first position information.

4. The image projection apparatus of claim 2, wherein, when executed individually or collectively by the at least one processor, the instructions further cause the image projection apparatus to:
convert a first 3D orthogonal coordinate system of the first pixel projection points into a second 3D orthogonal coordinate system of the second pixel projection points with respect to the viewpoint; and
project the second 3D orthogonal coordinate system onto a coordinate plane to obtain the second position information.

5. The image projection apparatus of claim 4, wherein, when executed individually or collectively by the at least one processor, the instructions further cause the image projection apparatus to correct the input image including adjust a size of a target pixel value based on the second position information to be inversely proportional to a depth value of the target pixel value in the second 3D orthogonal coordinate system.

6. The image projection apparatus of claim 2, wherein, when executed individually or collectively by the at least one processor, the instructions further cause the image projection apparatus to:
determine a specific weight based on a screen-to-image ratio; and
obtain, based on the second position information, information about a pixel coordinate system of a target pixel according to the specific weight and a separation distance between the target pixel and a reference pixel that corresponds to a center point in the second image display region.

7. The image projection apparatus of claim 2, wherein, when executed individually or collectively by the at least one processor, the instructions further cause the image projection apparatus to:
determine a specific weight based on a screen-to-image ratio;
obtain, based on the second position information, a first separation distance in a horizontal axis and a second separation distance in a vertical axis between a reference pixel and a target pixel with respect to a planar orthogonal coordinate system of the reference pixel, wherein the reference pixel corresponds to a center point of the second image display region; and
obtain information about a pixel coordinate system of the target pixel according to the specific weight, the first separation distance, and the second separation distance.

8. The image projection apparatus of claim 2, wherein the virtual projection plane includes a virtual plane facing the image projection apparatus at a predetermined distance between the projection plane and the image projection apparatus.

9. The image projection apparatus of claim 8, wherein, when executed individually or collectively by the at least one processor, the instructions further cause the image projection apparatus to set the third position information according to the predetermined distance between the image projection apparatus and the virtual projection plane.

10. The image projection apparatus of claim 1, wherein, when executed individually or collectively by the at least one processor, the instructions further cause the image projection apparatus to:
obtain the curvature characteristic of the projection plane based on the sensing data;
based on determining that the projection plane is a flat surface based on the curvature characteristic, perform a planar distortion correction on the input image to generate the output image;
based on determining that the projection plane is a multiple-plane surface based on the curvature characteristic, perform a multiple-plane distortion correction on the input image to generate the output image; and
based on determining that the projection plane is a curved surface based on the curvature characteristic, perform a curvature distortion correction on the input image to generate the output image.

11. A method for operating an image projection apparatus, the method comprising:
modeling a first image display region including first pixel projection points according to a curvature characteristic of a projection plane based on sensing data of at least one sensor;
obtaining second position information about second pixel projection points included in a second image display region according to a viewpoint of the projection plane, based on first position information about the first pixel projection points; and
generating an output image comprising correcting an input image based on the second position information, according to the curvature characteristic of the projection plane.

12. The method of claim 11, wherein the modeling the first image display region comprises:
obtaining a first depth value of the first pixel projection points included in the projection plane based on the sensing data of the at least one sensor; and
obtaining the first position information about the first pixel projection points based on the first depth value, and obtaining third position information about third pixel projection points included in a virtual projection plane, and
wherein the first position information includes information about a position in a three-dimensional (3D) orthogonal coordinate system, and the second position information and the third position information respectively include information about a position in a planar orthogonal coordinate system.

13. The method of claim 12, further comprising obtaining the information about the 3D orthogonal coordinate system, the obtaining the information comprises:
performing interpolation using the first depth value to obtain a second depth value of the first pixel projection points; and
applying the second depth value to the third position information to obtain the first position information.

14. The method of claim 12, further comprising obtaining the information about the planar orthogonal coordinate system, the obtaining the information comprises:
converting a first 3D orthogonal coordinate system of the first pixel projection points into a second 3D orthogonal coordinate system of the second pixel projection points with respect to the viewpoint; and
projecting the second 3D orthogonal coordinate system onto a coordinate plane to obtain the second position information.

15. The method of claim 14, wherein the correcting the input image comprises adjusting a size of a target pixel value based on the second position information to be inversely proportional to a depth value corresponding to the target pixel value in the second 3D orthogonal coordinate system.

16. The method of claim 12, wherein the generating the output image further comprises:
determining a specific weight based on a screen-to-image ratio; and
obtaining, based on the second position information, information about a pixel coordinate system of a target pixel based on the specific weight and a separation distance between the target pixel and a reference pixel that corresponds to a center point in the second image display region.

17. The method of claim 12, wherein the generating the output image further comprises:
determining a specific weight based on a screen-to-image ratio;
obtaining, based on the second position information, a first separation distance in a horizontal axis and a second separation distance in a vertical axis between a reference pixel and a target pixel using a planar orthogonal coordinate system of the reference pixel, wherein the reference pixel corresponds to a center point of the second image display region; and
obtaining information about a pixel coordinate system of the target pixel according to the specific weight, the first separation distance, and the second separation distance.

18. The method of claim 12, wherein the virtual projection plane includes a virtual plane facing the image projection apparatus at a predetermined distance between the projection plane and the image projection apparatus.

19. The method of claim 18, further comprising setting the third position information according to the predetermined distance between the image projection apparatus and the virtual projection plane.

20. The method of claim 11, further comprising:
obtaining the curvature characteristic of the projection plane based on the sensing data;
based on determining that the projection plane is a flat surface based on the curvature characteristic, generating the output image further comprises performing planar distortion correction on the input image;
based on determining that the projection plane is a multiple-plane surface based on the curvature characteristic, generating the output image further comprises performing a multiple-plane distortion correction on the input image; and
based on determining that the projection plane is a curved surface based on the curvature characteristic, generating the output image further comprises performing a curvature distortion correction on the input image.
